(19) United States
(12) Patent Application Publication
(10) Pub. No.: US 2012/0036201 A1
(43) Pub. Date: Feb. 9, 2012

(54) SOCIAL MEDIA ENGAGEMENT SYSTEM ROUTING AND MESSAGE ASSOCIATION

(75) Inventors: Kevin T. Cole, Charlotte, NC (US); David Scott Knapp, Gilbert, AZ (US)

(73) Assignee: BANK OF AMERICA CORPORATION, Charlotte, NC (US)

(21) Appl. No.: 13/018,327

(22) Filed: Jan. 31, 2011

Related U.S. Application Data
(63) Continuation-in-part of application No. 12/916,247, filed on Oct. 29, 2010.
(60) Provisional application No. 61/371,942, filed on Aug. 9, 2010.

(51) Int. Cl. G06F 15/16

(52) U.S. Cl. 709/206

(57) ABSTRACT

A social media engagement system is configured for aggregating a plurality of messages originating from a plurality of social media networks, routing each of the plurality of messages based on predetermined workflow rules into a plurality of queues wherein the queues are categorized based at least in part on types of messages, providing the queues for further processing, thereby resulting in one or more responses, and outputting the one or more responses to one or more of the plurality of social media networks. In some embodiments, the system is further configured for reviewing the data to determine whether any of the data indicates an engagement opportunity and associating some or all the data with a contact record and/or an existing case and/or a new case. In some embodiments, the system tracks influence, and in some embodiments, a console provides vision into various information provided by the system.

### CLAIM OF PRIORITY UNDER 35 U.S.C. §119

This Non-provisional patent application claims priority to Provisional Patent Application Ser. No. 61/371,942 titled “Social Media Engagement System” filed Aug. 9, 2010, assigned to the assignee hereof and hereby expressly incorporated by reference herein.

This Non-provisional patent application is a Continuation-in-Part of and also claims priority to patent application Ser. No. 12/916,247 titled “Social Media Engagement System” filed Oct. 29, 2010, assigned to the assignee hereof and hereby expressly incorporated by reference herein.

### FIELD

In general, embodiments of the invention relate to a social media engagement system. More specifically, embodiments of the invention relate to systems for aggregating, routing and responding to social media network messages.

### BACKGROUND

In recent history, social media repositories and the associated websites have vastly expanded the reach of the Internet. Social media has filled a niche that, for the most part, was nonexistent twenty years ago. People now stay connected with billions of other Internet users across the world twenty-four hours a day. Social media helps people find old friends, stay connected regarding current events of friends and family as well as current news happenings. With the proliferation of the Internet, the historical newspaper “scoop” lost much of its meaning as news traveled very quickly, and with the expansion of social media such as Facebook®, Twitter®, Linkedin®, YouTube® as well as a plethora of web logs or “blogs,” forums and other social spaces, everyone with an Internet connection has become a reporter.

In addition to connecting people with one another and providing a nearly instantaneous avenue for transmitting news across the globe, social media provides users and/or customers a quick and easy opportunity to communicate with organizations or enterprises. Further, in many instances, people communicate their experiences and/or opinions regarding organizations using social media. Hence, a system for assisting organizations to analyze social media communications and provide appropriate response is needed.

Therefore, a social media engagement system for aggregating data, such as social media messages, filtering and routing the messages to proper queues, and reviewing and responding to the messages is provided.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention address the above needs and/or achieve other advantages by providing methods, computer program products, and systems for social media engagement. According to embodiments of the invention, a method for social media engagement includes aggregating a plurality of messages originating from a plurality of social media networks, routing, by a processing device, each of the plurality of messages based on predetermined workflow rules into a plurality of queues wherein the queues are categorized based at least in part on types of messages, providing the queues for further processing, thereby resulting in one or more responses, and outputting the one or more responses to one or more of the plurality of social media networks.

In some such embodiments, aggregating the plurality of messages comprises searching a plurality of social media network messages accessed from the plurality of social media networks using predetermined searching criteria and retrieving one or more messages based on the search. In some such embodiments, aggregating the plurality of messages further comprises storing the plurality of messages originating from the plurality of social media networks.

In some embodiments, the method also includes reviewing the plurality of social media network messages to determine whether any of the messages indicates an engagement opportunity. In other embodiments, the method also includes preparing the one or more responses based on one or more of the social media network messages and based on which queue into which each of the one or more messages is routed.

In various other embodiments, the method also includes processing the aggregated plurality of messages. In some such embodiments, processing the aggregated plurality of messages comprises associating one or more of the messages with a contact record. In some such embodiments, processing the aggregated plurality of messages also comprises determining that the creator of one or more of the aggregated plurality of messages is associated with a pre-existing contact record stored in a memory device. In some such embodiments, associating one or more of the messages with a contact record comprises associating one or more of the messages with the pre-existing contact record.

In some embodiments, processing the aggregated plurality of messages comprises determining that the creator of one or more of the messages is not associated with a pre-existing contact record stored in a memory device and creating a new contact record associated with the creator. In some such embodiments, processing the aggregated plurality of messages further comprises associating one or more of the messages with the new contact record.

In some embodiments, processing the aggregated plurality of messages further comprises determining that the contact record has an existing case and associating one or more of the messages with the existing case. In some such embodiments, the existing case is an open case. In some embodiments, the existing case is a case closed within a predetermined period of time.

In some embodiments of the method, aggregating the plurality of messages comprises retrieving one or more messages from one or more authenticated accounts each associated with at least one of the plurality of social media networks. In some embodiments, aggregating the plurality of message further comprises searching a plurality of social media network messages accessed from the plurality of social media networks using predetermined searching criteria and retrieving one or more messages based on the search.

In some embodiments, the predetermined workflow rules comprise one or more rules configured for routing each of the messages based on the presence or absence of one or more keywords within each message.

In some embodiments of the method, outputting one or more responses to one or more of the plurality of social media networks comprises outputting one or more responses to one of the social media networks using an application programming interface of the social media network and communicating the one or more responses directly to the social media network without using and authentication account.

In some embodiments of the method, outputting one or more responses to one or more of the plurality of social media networks comprises authenticating with one of the social media networks using an account and communicating the one or more responses to the social media network using the authenticated account.

In some embodiments, the method also includes retrieving one or more social media profiles from the one or more social media networks, the one or more social media profiles corresponding with one or more of the plurality of messages and analyzing the one or more social media profiles to determine influence information indicating an influence of one or more of the plurality of messages.

In some embodiments, the method also includes initiating presentation of a social media engagement console to a user, the social media console providing immediate access from the console into at least two of one or more queues, one or more case details, one or more contact details, and one or more case messages.

According to embodiments of the invention, a social media engagement system includes a processing device configured for aggregating a plurality of messages originating from a plurality of social media networks, routing each of the plurality of messages based on predetermined workflow rules into a plurality of queues wherein the queues are categorized based at least in part on types of messages, providing the queues for further processing, thereby resulting in one or more responses, and outputting the one or more responses to one or more of the plurality of social media networks.

In some embodiments, aggregating the plurality of messages comprises searching a plurality of social media network messages accessed from the plurality of social media networks using predetermined searching criteria and retrieving one or more messages based on the search. In some such embodiments, aggregating the plurality of messages further comprises storing the plurality of messages originating from the plurality of social media networks.

In some embodiments, the processing device is further configured for reviewing the plurality of social media network messages to determine whether any of the messages indicates an engagement opportunity.

In some embodiments, the processing device is further configured for preparing the one or more responses based on one or more of the social media network messages and based on which queue into which each of the one or more messages is routed.

In some embodiments, the processing device is further configured for processing the aggregated plurality of messages. In some such embodiments, processing the aggregated plurality of messages comprises associating one or more of the messages with a contact record. In some such embodiments, processing the aggregated plurality of messages comprises determining that the creator of one or more of the aggregated plurality of messages is associated with a pre-existing contact record stored in a memory device. In some such embodiments, associating one or more of the messages with a contact record comprises associating one or more of the messages with the pre-existing contact record.

In some embodiments, processing the aggregated plurality of messages comprises determining that the creator of one or more of the messages is not associated with a pre-existing contact record stored in a memory device and creating a new contact record associated with the creator. In some such embodiments, processing the aggregated plurality of messages further comprises associating one or more of the messages with the new contact record.

In some embodiments, processing the aggregated plurality of messages further comprises determining that the contact record has an existing case and associating one or more of the messages with the existing case. In some such embodiments, the existing case is an open case. In some such embodiments, the existing case is a case closed within a predetermined period of time.

In some embodiments, aggregating the plurality of messages comprises retrieving one or more messages from one or more authenticated accounts each associated with at least one of the plurality of social media networks. In some such embodiments, aggregating the plurality of message further comprises searching a plurality of social media network messages accessed from the plurality of social media networks using predetermined searching criteria and retrieving one or more messages based on the search.

In some embodiments, the predetermined workflow rules comprise one or more rules configured for routing each of the messages based on the presence or absence of one or more keywords within each message.

In some embodiments, outputting one or more responses to one or more of the plurality of social media networks comprises outputting one or more responses to one of the social media networks using an application programming interface of the social media network and communicating the one or more responses directly to the social media network without using and authentication account.

In some embodiments, outputting one or more responses to one or more of the plurality of social media networks comprises authenticating with one of the social media networks using an account and communicating the one or more responses to the social media network using the authenticated account.

In some embodiments, the processing device is further configured for retrieving one or more social media profiles from the one or more social media networks, the one or more social media profiles corresponding with one or more of the plurality of messages and analyzing the one or more social media profiles to determine influence information indicating an influence of one or more of the plurality of messages. In other embodiments, the processing device is further configured for initiating presentation of a social media engagement console to a user, the social media console providing immediate access from the console into at least two of one or more queues, one or more case details, one or more contact details, and one or more case messages.

According to embodiments of the invention, a computer program product for social media engagement includes a non-transitory computer readable medium comprising computer-readable instructions. The instructions include instructions for aggregating a plurality of messages originating from a plurality of social media networks, instructions for routing each of the plurality of messages based on predetermined workflow rules into a plurality of queues wherein the queues are categorized based at least in part on types of messages, instructions for providing the queues for further processing, thereby resulting in one or more responses, and instructions for outputting the one or more responses to one or more of the plurality of social media networks. In some such embodiments, the instructions for aggregating the plurality of messages comprise instructions for searching a plurality of social media network messages accessed from the plurality of social media networks using predetermined searching criteria and instructions for retrieving one or more messages based on the search. In some such embodiments, the instructions for aggregating the plurality of messages further comprise instructions for storing the plurality of messages originating from the plurality of social media networks.

In some embodiments, the instructions further comprise instructions for reviewing the plurality of social media network messages to determine whether any of the messages indicates an engagement opportunity. In some embodiments, the instructions further comprise instructions for preparing the one or more responses based on one or more of the social media network messages and based on which queue into which each of the one or more messages is routed.

In some embodiments, the instructions further comprise instructions for processing the aggregated plurality of messages. In some such embodiments, the instructions for processing the aggregated plurality of messages comprise instructions for associating one or more of the messages with a contact record. In some such embodiments, the instructions for processing the aggregated plurality of messages comprise instructions for determining that the creator of one or more of the aggregated plurality of messages is associated with a pre-existing contact record stored in a memory device. In some such embodiments, the instructions for associating one or more of the messages with a contact record comprise instructions for associating one or more of the messages with the pre-existing contact record.

In some embodiments, the instructions for processing the aggregated plurality of messages comprise instructions for determining that the creator of one or more of the messages is not associated with a pre-existing contact record stored in a memory device and instructions for creating a new contact record associated with the creator. In some such embodiments, the instructions for processing the aggregated plurality of messages further comprise instructions for associating one or more of the messages with the new contact record.

In some embodiments, the instructions for processing the aggregated plurality of messages further comprise instructions for determining that the contact record has an existing case and instructions for associating one or more of the messages with the existing case. In some such embodiments, the existing case is an open case. In some embodiments, the existing case is a case closed within a predetermined period of time.

In some embodiments, the instructions for aggregating the plurality of messages comprise instructions for retrieving one or more messages from one or more authenticated accounts each associated with at least one of the plurality of social media networks. In some such embodiments, the instructions for aggregating the plurality of message further comprise instructions for searching a plurality of social media network messages accessed from the plurality of social media networks using predetermined searching criteria and instructions for retrieving one or more messages based on the search.

In some embodiments, the predetermined workflow rules comprise one or more rules configured for routing each of the messages based on the presence or absence of one or more keywords within each message.

In some embodiments, the instructions for outputting one or more responses to one or more of the plurality of social media networks comprise instructions for outputting one or more responses to one of the social media networks using an application programming interface of the social media network and instructions for communicating the one or more responses directly to the social media network without using and authentication account.

In some embodiments, the instructions for outputting one or more responses to one or more of the plurality of social media networks comprise instructions for authenticating with one of the social media networks using an account and instructions for communicating the one or more responses to the social media network using the authenticated account.

In some embodiments, the instructions further comprise instructions for retrieving one or more social media profiles from the one or more social media networks, the one or more social media profiles corresponding with one or more of the plurality of messages and instructions for analyzing the one or more social media profiles to determine influence information indicating an influence of one or more of the plurality of messages.

In some embodiments, the instructions further comprise instructions for initiating presentation of a social media engagement console to a user, the social media console providing immediate access from the console into at least two of one or more queues, one or more case details, one or more contact details, and one or more case messages.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a flowchart illustrating a method for social media engagement according to embodiments of the invention;

FIGS. 2A-2D are flowcharts illustrating a method for social media engagement similar to the method of FIG. 1 having additional detail according to embodiments of the invention;

FIGS. 3A-3B are flowcharts illustrating a method including logical steps for social media engagement according to embodiments of the invention;

FIG. 4 is a flowchart illustrating another method for social media engagement according to embodiments of the invention;

FIG. 5 is a flowchart illustrating another method for social media engagement including aggregation of data from multiple social media systems according to embodiments of the invention;

FIG. 6 is a block diagram of a social media engagement environment in which the various methods described herein are performed according to embodiments of the invention;

FIGS. 7A-7C illustrate screenshots of a social media engagement platform according to embodiments of the invention;

FIG. 8 is a flowchart illustrating a method for message case association according to embodiments of the invention;

FIG. 9 is a flowchart illustrating a method for message routing according to embodiments of the invention;

FIG. 10 is a flowchart illustrating a method for processing a message according to embodiments of the invention;

FIG. 11 is a flowchart illustrating a method for interacting with a social media network using a social media engagement system according to embodiments of the invention;

FIG. 12 is a flowchart illustrating a method for communicating with a social media network;

FIG. 13 is a flowchart illustrating a method for message association according to embodiments of the invention;

FIG. 14 is a flowchart illustrating a method for tracking influence over at least one social media network according to embodiments of the invention; and

FIG. 15 is a flowchart illustrating a method for providing a console to a user of a social media engagement system according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention provide for systems for social media engagement. The system, in various embodiments, has a processing device configured for aggregating a plurality of messages originating from a plurality of social media networks, routing each of the plurality of messages based on predetermined workflow rules into a plurality of queues wherein the queues are categorized based at least in part on types of messages, providing the queues for further processing, thereby resulting in one or more responses, and outputting the one or more responses to one or more of the plurality of social media networks. In some embodiments, the system is further configured for reviewing the data to determine whether any of the data indicates an engagement opportunity and associating some or all the data with a contact record and/or an existing case and/or a new case. In some embodiments, the system tracks influence, and in some embodiments, a console provides vision into various information provided by the system.

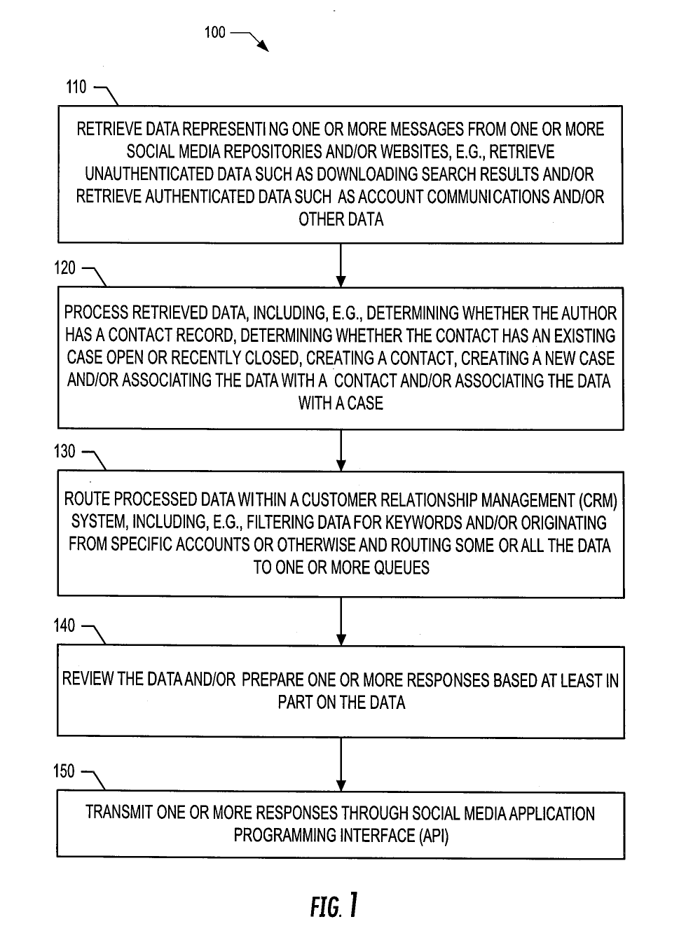

Referring to FIG. 1, a flowchart illustrates a method 100 for social media engagement according to embodiments of the present invention. The first step, as represented by block 110, is to retrieve data representing one or more messages from one or more social media repositories, websites and/or systems. For example, in some embodiments, unauthenticated data such as search results are downloaded from one or more social media systems. The data is considered unauthenticated because it was not sent to an enterprise-specific account. In other embodiments, for example, authenticated data, such as data communicated via one or more authenticated enterprise-specific accounts is retrieved. In some embodiments, wherein unauthenticated data is downloaded, specific keyword searches are performed, such as variations on the name of the enterprise, including, in some embodiments, misspellings of various names of the enterprise or other search terms likely to recover relevant unauthenticated data from the social media systems.

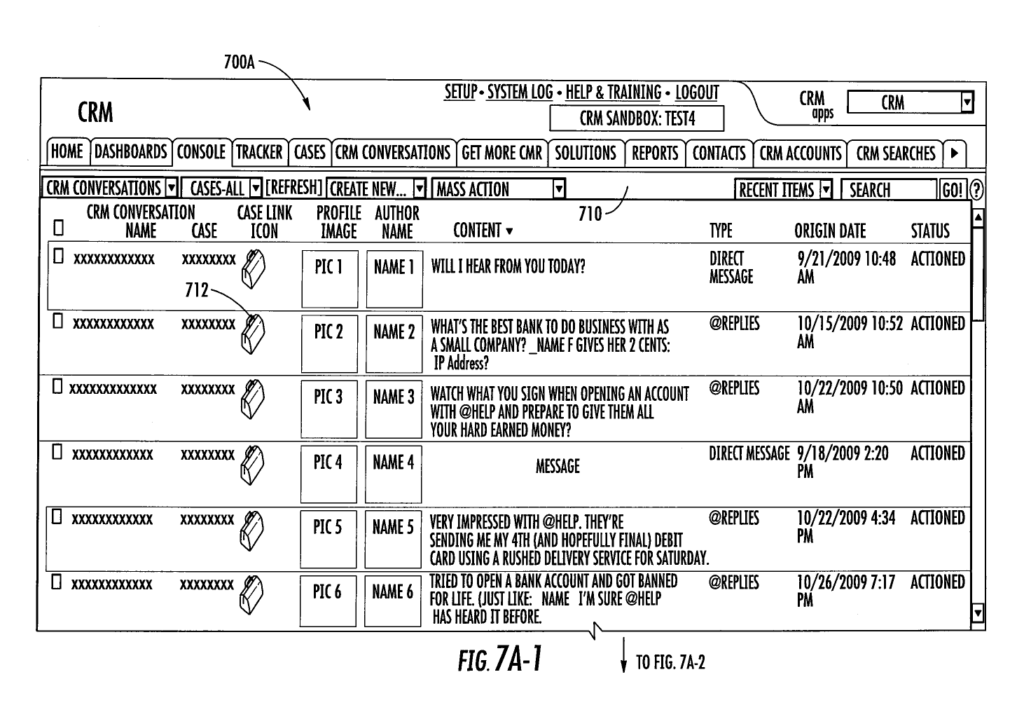

The next step, as represented by block 120, is to process the retrieved data. In some embodiments, the processing includes, for example, determining whether the creator of the data, such as an author of one or more messages, has a contact record stored by an enterprise or organization, such as at the enterprise server and/or in a datastore, such as a datastore associated with a customer relationship management (CRM) system (see FIG. 6). In some embodiments, for example, processing the retrieved data includes determining whether the contact has an existing case open and/or recently closed. In some embodiments, for example, processing the retrieved data includes creating a contact record, creating a new case, and/or associating the data with a contact record and/or associating the data with a case.

The next step, as represented by block 130, is to route the processed data within the customer relationship management (CRM) system, such as, for example, an enterprise system maintained by an enterprise. Routing the processed data, in some embodiments, for example, includes filtering the data for keywords and/or filtering the data to determine whether it originated from one or more specific accounts. In some embodiments, for example, routing the processed data includes routing some or all the data to one or more queues. For example, in some embodiments, the unauthenticated data, generally downloaded search results, is routed to one or more search results queues and/or one or more case inbox queues. In other embodiments, for example, authenticated data, such as data from messages sent to specific authenticated accounts, for example, one or more accounts maintained by the enterprise or organization, is routed to one or more case inbox queues.

The next step, as represented by block 140, is to review the data and/or prepare one or more responses based at least in part on the reviewed data. In some embodiments, for example, the data, such as multiple messages sitting in one or more queues, is reviewed manually by one or more associates of the enterprise in order to determine whether any of the messages required engagement such as beginning a dialogue with the messages author(s). In other embodiments, for example, the review is performed automatically such as by the processing device of the enterprise system in order to determine whether one or more of the messages requires engagement. In some embodiments, once it is determined a piece of data, such as a message, does not require engagement, the piece of data is ignored and/or discarded. In some embodiments, the piece of data is retained and flagged as reviewed for engagement.

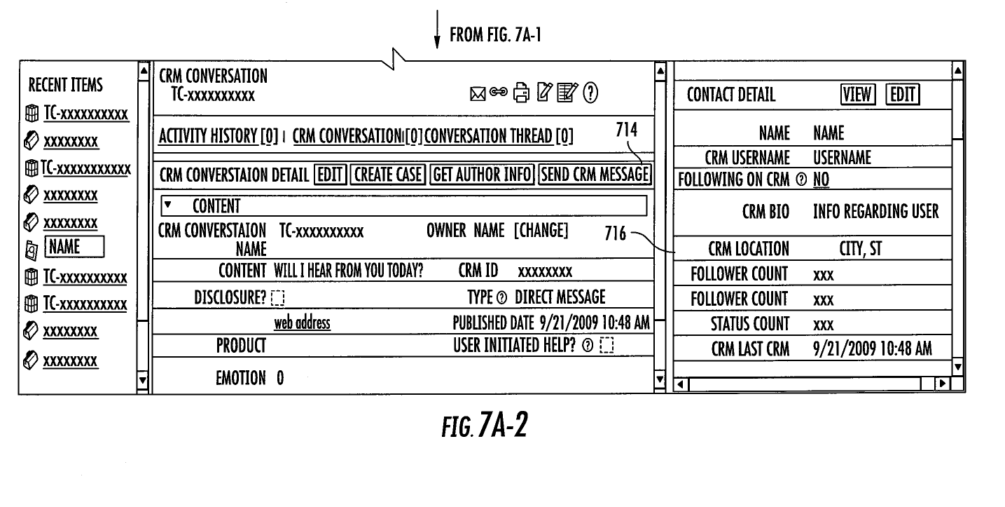

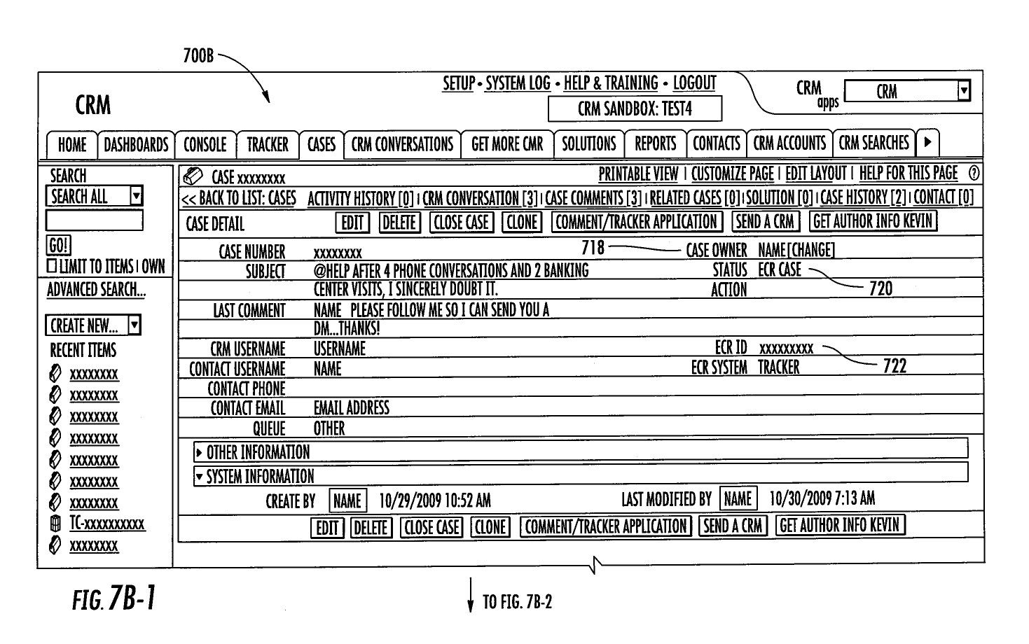

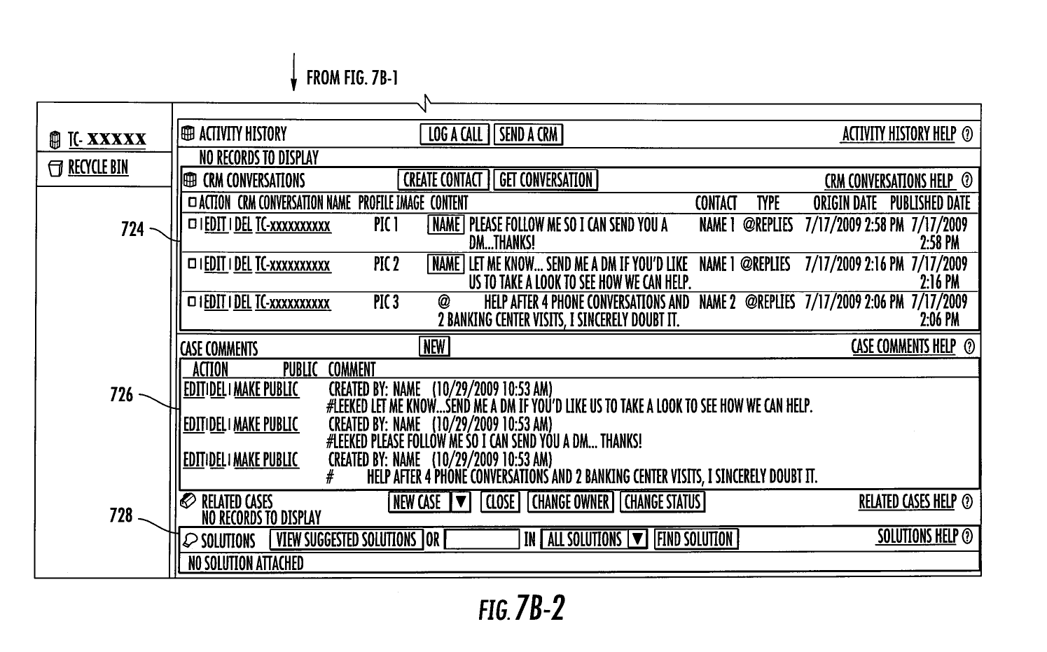

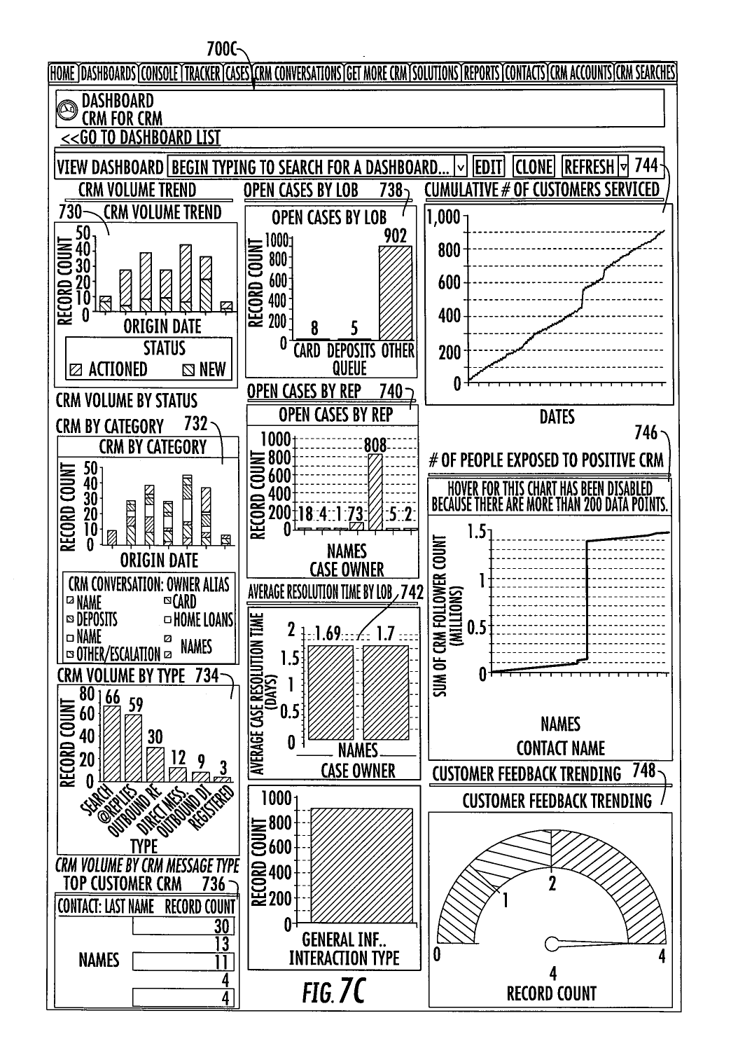

Finally, the next step, as represented by block 150, is to transmit one or more responses through one or more social media application programming interfaces (APIs). In some embodiments, for example, the enterprise system processing device instructs the communication device to interact with the API of a specific social media system external to the enterprise system in order to communicate a response message. In some embodiments, the enterprise system includes an application, such as the CRM, workflow, and/or case management system/platform application (“CRM application”) as shown in FIG. 6, including program code integrating one or more social media system APIs such that a user of the enterprise system or the system by itself can transmit a message within a CRM application such as a console interface (as shown in FIG. 7). In other embodiments, the enterprise system forwards the user to the external website of the social media system, and in some such embodiments, the enterprise system automatically authenticates the user with a predetermined account of the enterprise. Once authenticated with the external social media system website, the user is able to transmit the desired message. In various embodiments, the enterprise system initiates communication of the one or more responses, and in various other embodiments, the enterprise system output the one or more responses. In some embodiments, for example, the enterprise system initiates communication of the responses by providing instructions to a communication device or system that is configured for communicating the one or more responses. In some other embodiments, the enterprise system itself outputs the responses and/or instructions for outputting the responses. In some embodiments, outputting refers to uploading the responses to the social media network.

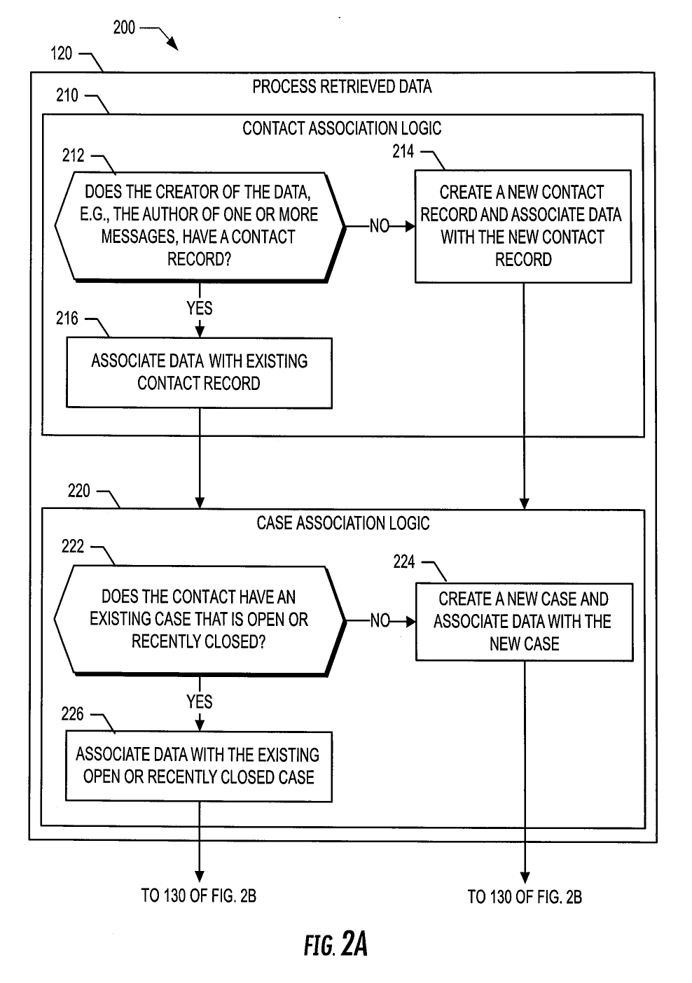

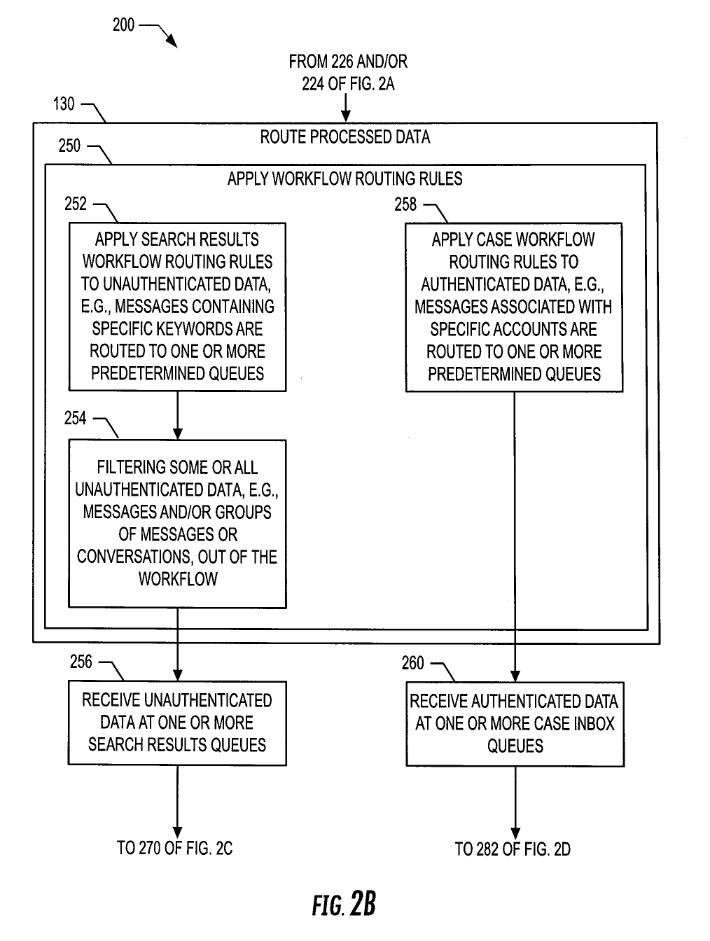

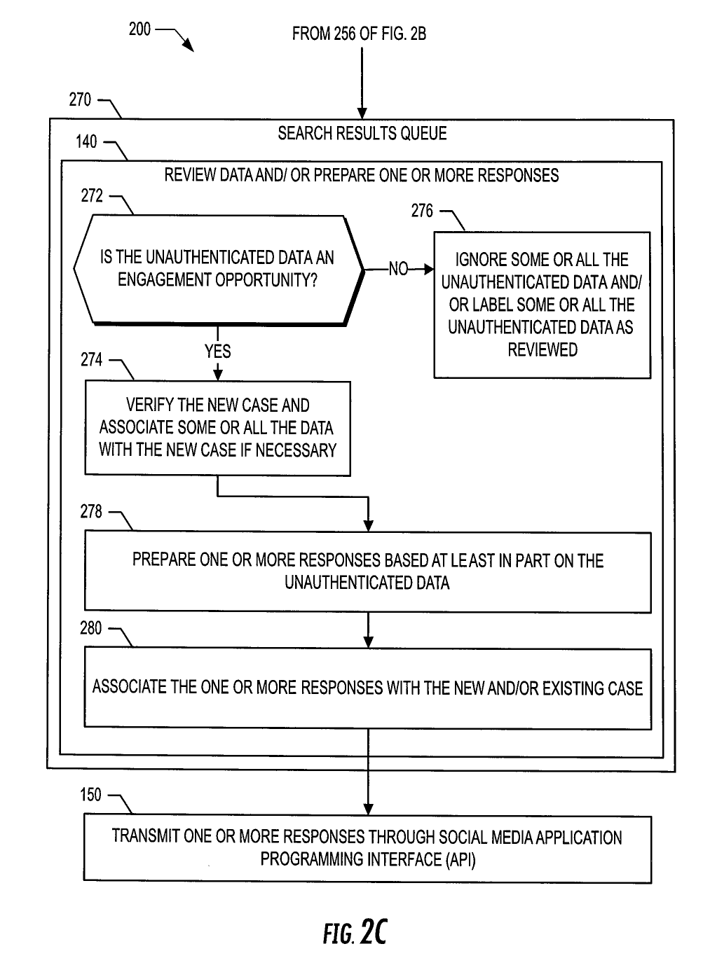

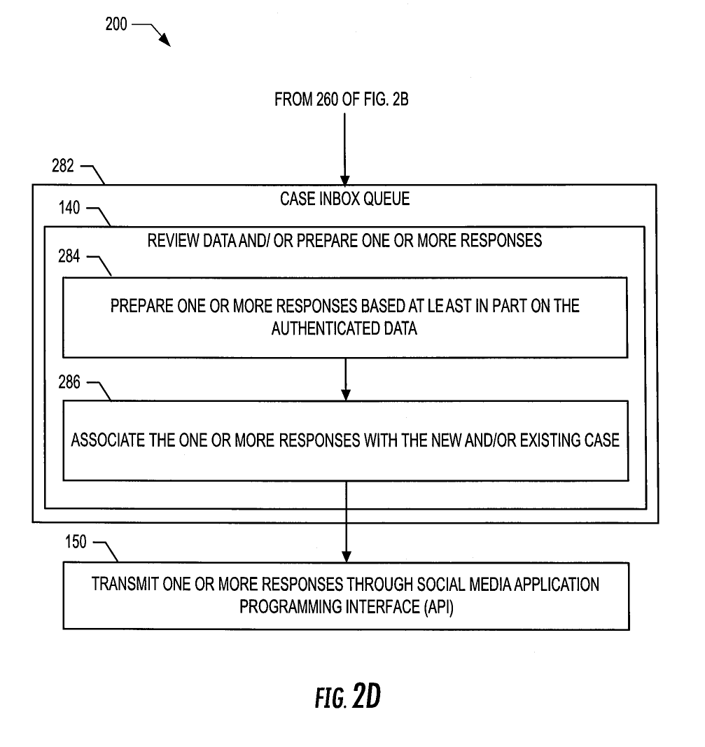

Referring now to FIGS. 2A-2D, flowcharts illustrate a method 200 for social media engagement similar to the method 100 of FIG. 1 but including additional detail according to embodiments of the present invention. The first step, which is not shown, is the same as step 110 of FIG. 1, that is, retrieving data from one or more social media systems.

Referring now to FIG. 2A, the next step, as represented by block 120, is to process the retrieved data as discussed above. Step 120 includes, in some embodiments, contact association logic 210, and in some embodiments, includes case association logic 220. The contact association logic 210 and the case association logic 220 in various embodiments represent one or more piece of hardware and/or one or more pieces of program code configured to control the one or more pieces of hardware. In one embodiment, for example, the contact association logic 210 and the case association logic 220 are software algorithms stored in the CRM application of the enterprise system and are configured for instructing the processing device of the enterprise system (see FIG. 6).

In various embodiments, the contact association logic 210 includes determining whether the creator of the data, such as an author of one or more messages, has a contact record, as represented by decision block 212. If the creator of the data does have a contact record, the next step, as represented by block 216, is to associate some or all the data with the existing contact record in some embodiments. If the creator of the data does not have a contact record, the next step, as represented by block 214, is to create a new contact record and associate the data with the new contact record.

In some embodiments, when creating a new contact records or, in various embodiments, when accessing a pre-existing contact record, the contact association logic 210 is also configured for downloading one or more social media profiles from the social media system in order to distill information regarding the creator of the data and input such information in the new contact record and/or update the pre-existing contact record.

Next, the method 200 moves to the case association logic 220. The case association logic 220, in various embodiments, includes determining whether the contact has an existing case that is open and/or recently closed, as represented by decision block 222. If the contact has an existing case that is open and/or recently close, the next step, as represented by block 226 is to associate some or all the data with the existing open and/or recently closed case. If the contact does not have an existing open and/or recently closed case, the next step, as represented by block 224 is to create a new case and associate the data with the new case.

In various embodiments, the data is unauthenticated search results or includes unauthenticated search results and processing the retrieved data includes both the contact association logic as well as the case association logic. In various other embodiments, the data is authenticated data, for example, one or more messages sent to a specified enterprise account, and processing the retrieved data includes both the contact association logic as well as the case association logic. In various other embodiments, the data is both unauthenticated data and authenticated data and processing the retrieved data includes both contact association logic and case association logic. In various other embodiments, processing the retrieved data, which in some embodiments includes unauthenticated data, authenticated data or both, includes either contact association logic or case association logic but not both. In yet other embodiments, processing the retrieved data, which in some embodiments includes unauthenticated data, authenticated data or both, includes neither contact association logic nor case association logic.

Referring now to FIG. 2B, the next step in the method 200, is step 130, originally presented in FIG. 1, which is routing the processed data. Routing the processed data, in various embodiments, includes applying workflow routing rules, as represented by block 250. For example, in one embodiment where the enterprise is a financial institution such as a bank, the workflow rules identify the data, messages and/or cases to be routed to a “card queue” configured for data regarding a credit or debit card issued by the financial institution. Various examples of workflow rules are configured for retrieving data including the following terms: “card queue” include “apr”, “credit”, “business card”, “card”, finance charge”, “lost”, “stolen”, maintenance fee”, and the like. In another example, in one embodiment, where the enterprise is a financial institution such as a bank, the workflow rules identify the data, messages and/or cases to be routed to a “deposits queue” configured for data regarding a demand deposit account or the like. Various examples of workflow rules are configured for retrieving data including the following terms: “account”, “auto bill pay”, “balance”, “cashiers check”, “checking”, direct deposit”, and the like. In yet another example, in one embodiment, where the enterprise is a financial institution such as a bank, the workflow rules identify the data, messages and/or cases to be filtered out of the data being reviewed because of its foreign language characteristics. Various examples of workflow rules are configured for filtering out data including the following terms: “sorte”, “noite”, “tarde”, and the like, and configured for retaining data including the following: “maintenance fee”, “mortgage rate”, “checking”, “deposit”, and the like. It should be understood that the example listings above are not exhaustive and are merely provided for example purposes. The workflow rules applied, in various embodiments, include many additional keyword rules or include fewer keyword rules. Further, in some embodiments, the rules may include additional rules unrelated to keyword rules. For example, in various embodiments, the workflow rules also include rules related to the account from which the message was sent and/or to which the message is being sent.

In some embodiments and uses of the method 200, the next step, as represented by block 252, is to apply search results workflow routing rules to unauthenticated data. For example, in some embodiments, one or more messages containing specific keywords are routed to one or more predetermined queues. In some such embodiments, the next step, as represented by block 254, is to filter some or all the unauthenticated data. For example, in some embodiments, one or more messages and/or groups of messages or conversations are filtered out of the workflow. As discussed elsewhere herein, in some embodiments, the filtered messages are discarded and/or deleted, and in some embodiments, some or all the filtered messages are retained and/or flagged as having been filtered out of the workflow.

In some embodiments and uses of the method 200, the next step, instead of steps 252 and 254, is to apply case workflow routing rules, as represented by block 258. For example, in some embodiments, one or more messages associated with specific accounts, such as one or more accounts maintained by the enterprise, are routed to one or more predetermined queues.

Once the workflow routing rules have been applied in step 250, the next step is to receive the data at one or more queues. In cases where unauthenticated data is being manipulated, the next step, as represented by block 256, is to receive the unauthenticated data at one or more search results queues. In cases where authenticated data is being manipulated, the next step, as represented by block 260, is to receive the authenticated data at one or more case inbox queues.

Referring now to FIG. 2C, in the case where unauthenticated data is being manipulated, the unauthenticated data has been routed into one or more search results queues 270. The unauthenticated data, as represented by block 140, originally presented in FIG. 1, is reviewed, and in some embodiments, one or more responses are prepared. The first step of the review is to determine whether the unauthenticated data presents an engagement opportunity, as represented by block 272. If the unauthenticated data does not present an engagement opportunity, as represented by block 276, the next step is to ignore some or all the unauthenticated data and/or label some or all the unauthenticated data as having been reviewed for engagement. In some embodiments, discussed above, the data not presenting an engagement opportunity is discarded and in others it is stored.

If the authenticated data does present an engagement opportunity, as represented by block 274, the next step is to verify the new case and, once verified, associate some or all the data with the new case if necessary. In some other embodiments, where a new case had not already been created, a new case is created here as well. The next step, as represented by block 278, is to prepare one or more responses based at least in part on the unauthenticated data. As discussed above, in some embodiment, some or all of step 278 is performed manually, such as, by an associate of the enterprise. In other embodiments, some or all of step 278 is performed by the enterprise system and/or some other system. For example, in some embodiments, one or more predetermined messages are prepared in response to the unauthenticated data.

The next step, as represented by block 280, is to associate the one or more responses with the new and/or existing case. The final step, represented by block 150, as first presented with reference to FIG. 1, is to transmit the one or more responses through the social media application programming interface (API). In some embodiments, the API is integrated with the CRM application of the enterprise server, and in other embodiments, the CRM application of the enterprise server forwards the user to the corresponding social media website, in some embodiments, authenticates the user using an enterprise account, and transmits one or more responses using the API of the social media system.

Referring now to FIG. 2D, in the case where authenticated data is being manipulated, the authenticated data has been routed to and received at one or more case inbox queues 282, as discussed above with reference to block 260 of FIG. 2B. The authenticated data is first reviewed and one or more responses are prepared as represented by block 140, originally presented in FIG. 1. In some embodiments, one or more responses are prepared based at least in part on the authenticated data as represented by block 284. Next, as represented by block 286, the one or more responses are associated with the new and/or existing case. Finally, as represented by block 150, originally presented in FIG. 1, the next step is to transmit one or more responses through the social media API. As discussed above, in some embodiments, the API is integrated with the CRM application of the enterprise server, and in other embodiments, the CRM application of the enterprise server forwards the user to the corresponding social media website, in some embodiments, authenticates the user using an enterprise account, and transmits one or more responses using the API of the social media system.

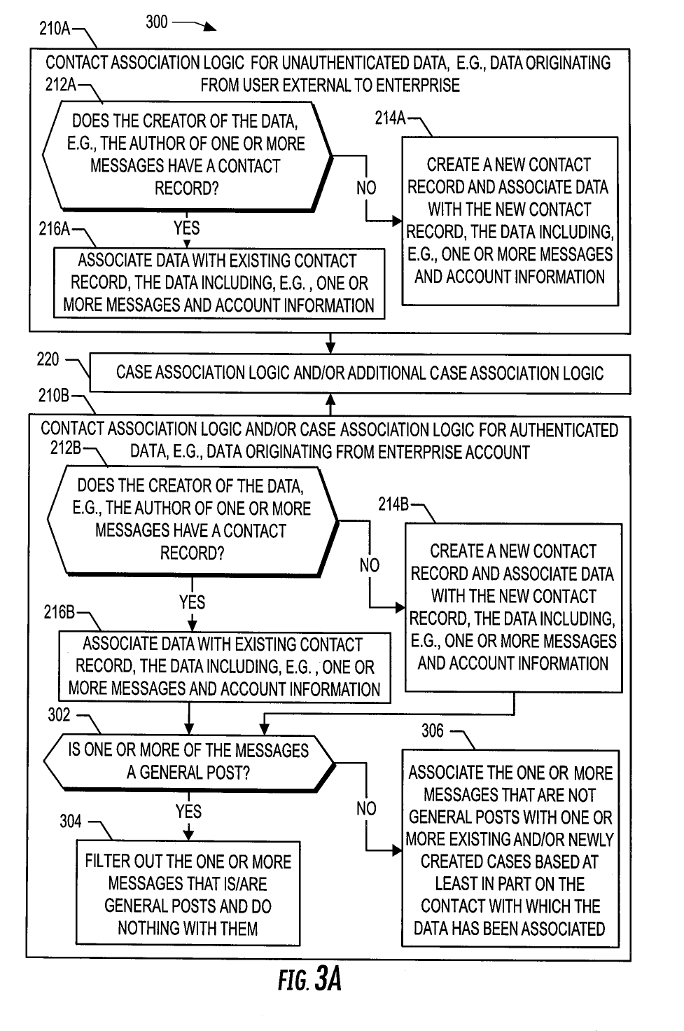

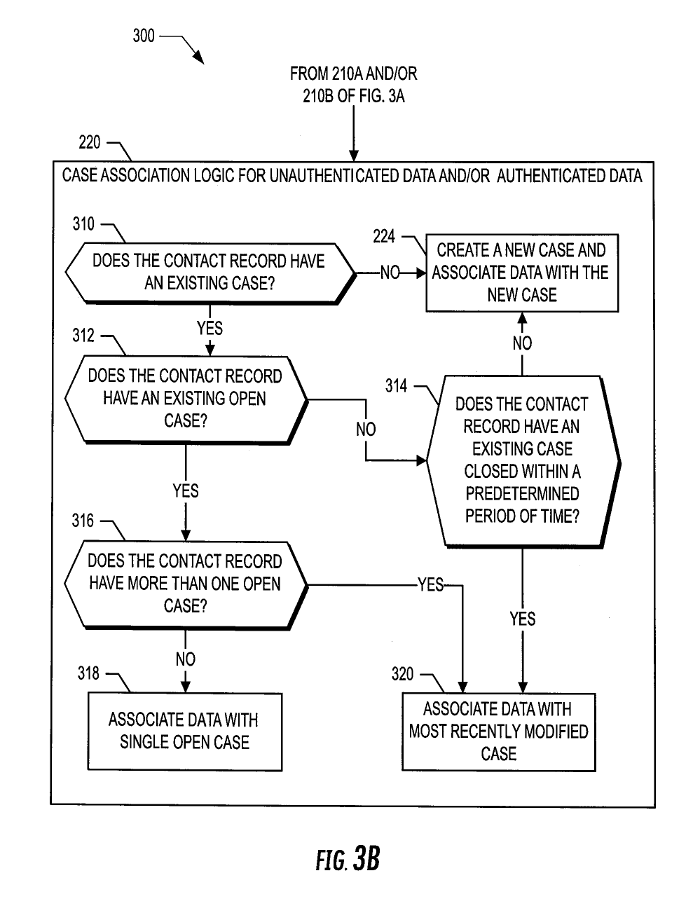

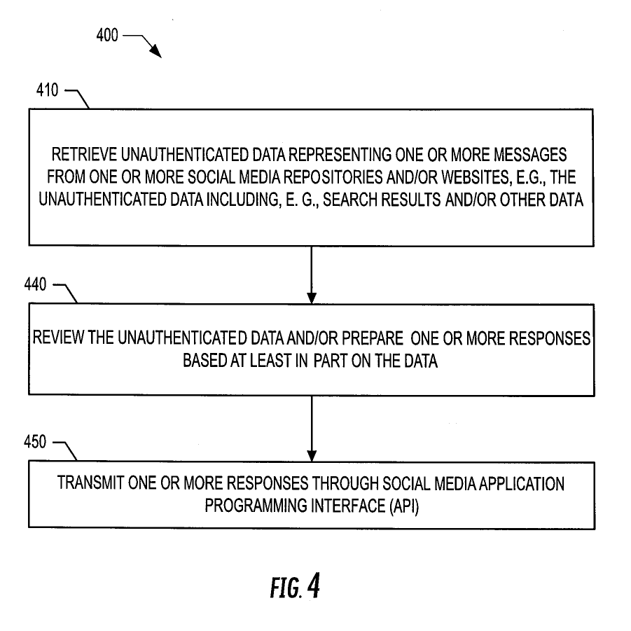

Referring now to FIGS. 3A-3B, flowcharts illustrate a method 300 including logical steps for social media engagement according to embodiments of the present invention. The contact association logic 210A for unauthenticated data (referred to herein as logic 210A) and the contact association logic and/or case association logic 210B for authenticated data (referred to herein as logic 210B) are shown feeding the case association logic and/or additional case association logic 220 (referred to herein as logic 220). Logic 210A, is applied to the unauthenticated data, such as, for example, data originating from a user external to the enterprise. For example, in some instances, a user authors a message on a social media service maintained by a social media system. The message is found and retrieved based on the retrieval of step 110, and in some embodiments, the workflow routing rules of step 250. The user, in this example, is not authenticated through an enterprise-maintained account. Thus, the message is considered unauthenticated data.

In some embodiments, the first step is to determine whether the creator of the data, for example, the author of one or more messages, has a contact record stored, for example, in enterprise system such that the CRM application has access to it. The determination is represented in FIG. 3A by decision block 212A. If the creator of the data does not have a contact record, in some embodiments, the next step, as represented by block 214A, is to create a new contact record and associate some or all the unauthenticated data with the new contact record. In some embodiments, for example, the unauthenticated data includes one or more messages and/or account information regarding the account from which the one or more messages originated. If the creator of the data does have a contact record, in some embodiments, the next step, as represented by block 216A, is to associate some or all the unauthenticated data with the existing contact record. As with the above step, the unauthenticated data, in various embodiments, includes one or more messages and/or account information. Next, the method 300 proceeds to logic 220 as further discussed with reference to FIG. 3B below.

Referring to the lower portion of FIG. 3A, logic 210B is shown. The first step of logic 210B is to determine whether the creator of the authenticated data has a contact record, as represented by decision block 212B. If the creator of the authenticated data does not have a contact record, the next step, as represented by block 214B, is to create a new contact record and associate some or all the authenticated data with the new contact record. In various embodiments, the authenticated data includes, for example, one or more messages and/or account information indicating an account maintained by the enterprise from which the one or more messages were associated. If the creator of the authenticated data does have a contact record, the next step, as represented by block 216B, is to associate some or all the authenticated data with the existing contact record. In various embodiments, the authenticated data includes one or more messages and/or account information tending to identify the account maintained by the enterprise from which the one or more messages were transmitted.

The next step is fed by both blocks 214B and 216B, and is represented by decision block 302. This step is to determine whether some or all of the data is a general post. For example, in some embodiments, one or more of the messages included in the data may be a general post without one or more specific recipients intended. That is, such messages are intended for indiscriminant public dissemination. If some or all the authenticated data is a general post, the next step, as represented by block 304, is to filter out the one or more messages that is/are general posts and do nothing with them. For example, in one embodiment, the messages intended as general posts need no case association or engagement or other type of response, and therefore, such messages are filtered and ignored. If some or all the authenticated data is not a general post, the next step, as represented by block 306, is to associate the one or more messages that are not general posts with the one or more existing and/or newly created cases based at least in part on the contact record with which the authenticated data has been associated. Next, the method 300 proceeds to logic 220 as further discussed with reference to FIG. 3B below. In some embodiments, steps 302, 304 and/or 306 are part of logic 220 rather than logic 210B.

Referring now to FIG. 3B, the first step of logic 220 is to determine whether the contact record has an existing case, as represented by decision block 310. If the contact record does not have an existing case, the next step is to create a new case and associate the data, authenticated, unauthenticated or both, with the new case as represented by block 224. If the contact record does have an existing case, as represented by decision block 312, the next step is to determine whether the contact record has an existing open case. If the contact record has an existing open case, the method 300 moves to decision block 316, and if the contact record does not have an existing open case, the method 300 moves to decision block 314. Decision block 316 represents determining whether the contact record has more than one open case. If not, the next step, as represented by block 318, is to associate some or all the data with the single open case. If so, the next step, as represented by block 320 is to associate some or all the data with the most recently modified case. Decision block 314 represents determining whether the contact record has an existing case closed within a predetermined period of time. If so, the next step is to associate some or all the data with the most recently modified case as represented by block 320. If not, the next step is to create a new case and associate some or all the data with the newly created case as represented by block 224.

Thus, in one embodiment, for example, search results (unauthenticated data) are downloaded from a social media system to an enterprise system. The enterprise system includes contact association logic that determines whether the author has a contact record. If not, one is created and the data is associated to the new contact record. If so, the data is associated with an old contact record. Next, the case association logic of the enterprise system determines whether the contact record has an existing case open or recently closed. If so, the data is associated with the existing case, and if not, the data is associated with a newly created case. Then, the enterprise system applies workflow routing rules and the unauthenticated data is routed into one or more appropriate search results queues, where the data is reviewed and one or more messages are prepared in response to the data if the data is determined to be an appropriate engagement opportunity.

In another embodiment, for example, account communications (authenticated data) are retrieved from a social media system and/or from an internal filter configured for retrieving and/or copying data sent from users to enterprise accounts. The enterprise system's contact association logic determines whether the author has a contact record. If not, one is created and the data is associated to the new contact record. If so, the data is associated with an old contact record. Next, the case association logic of the enterprise system determines whether the contact record has an existing case open or recently closed. If so, the data is associated with the existing case, and if not, the data is associated with a newly created case. Then, the enterprise system applies workflow routing rules and the authenticated data is routed into one or more appropriate case inbox queues, where the data is reviewed and one or more messages are prepared in response to the data.

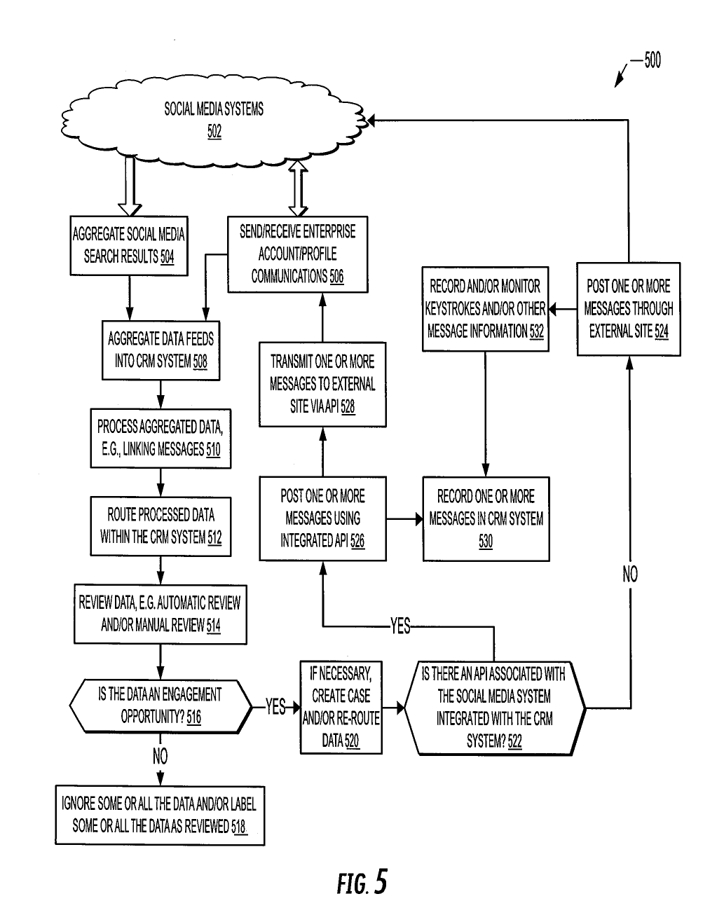

Referring now to FIG. 4, a flowchart illustrates another method for social media engagement according to embodiments of the present invention. In the embodiment shown, the method involves unauthenticated data, and no case association logic is used. The first step in the method 400, as represented by block 410, is to retrieve unauthenticated data representing one or more message from one or more social media repositories, websites, systems and/or the like. For example, the unauthenticated data may include search results and/or other data. Next, as represented by block 440, the enterprise system reviews the unauthenticated data and/or prepares one or more responses based at least in part on the data. In various embodiments, such as those discussed above, step 440 includes determining whether there is an engagement opportunity with regard to the data, and if so, creating a new case and associating some or all the data with the new case. In some embodiments, the new case is created manually, and in others, the new case is created by the enterprise system. If not, some or all the data is ignored or stored and flagged in some embodiments. Finally, as represented by block 450, the enterprise system transmits the one or more responses using the social media API as discussed above.

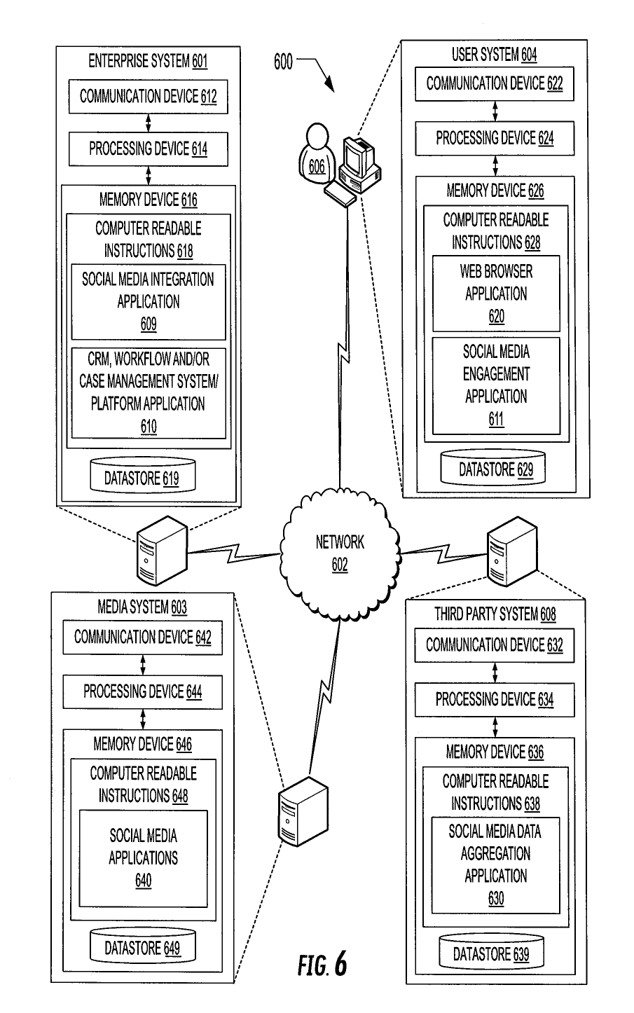

Referring now to FIG. 5, a flowchart illustrates another method 500 for social media engagement including aggregation of data from multiple social media systems according to embodiments of the present invention. One or more social media systems 502 are represented by the cloud at the top of FIG. 5. The first step, as represented by block 504, is to aggregate social media search results. The search results are collected and/or “listened” for by a social media aggregation system or some other system executing a social media data aggregation application, such as application 630 of FIG. 6. In alternate embodiments, various data aggregation applications are used individually and/or in combination. As represented by block 506, data is also retrieved from one or more of the social media systems 502 in the form of sending and/or receiving enterprise account and/or profile communications. For example, in one embodiment, a client transmits a social media message to a specific account maintained by an enterprise.

The data from both the search results aggregation and the account communications is fed into block 508, which represents aggregating the data feeds into a CRM system, such as an enterprise system 601 executing a CRM application 610 (See FIG. 6). Step 508, in some embodiments, is performed by a processing device of an enterprise system executing a social media integration application, such as 609 of FIG. 6. In various other embodiments, other systems aggregate the data feeds into the CRM system.

Steps 510, 512, 514, and others in method 500 are very similar to various steps performed in the methods 100, 200, 300, and 400 discussed above. However, the steps of method 500 illustrate integration of data manipulation across multiple social media systems as opposed to the somewhat simpler manipulation of data from a single social media system as illustrated in methods 100, 200, 300, and 400 discussed above. As represented by block 510, the next step of method 500, is to process the aggregated data, including both aggregated social media search results as well as enterprise account communications, and thus, both unauthenticated and authenticated data. As discussed above, contact association logic is used to associate the data into appropriate contact records. Also, as discussed above, case association logic is used to link data together. The data, in some embodiments, includes one or more messages and/or groups of messages that are associated by the case association logic into a case or some other construct such as a “conversation” or group of message directed to a specific topic and related to a single user/customer. The next step, as represented by block 512, is to route the processed data within the CRM system. Step 512, in some embodiments, includes filtering data through, for example, workflow rules into appropriate queues, such as one or more search results queues and/or one or more case inbox queues. As represented by block 514, the next step is the review the data. For example, in some embodiments, an enterprise associate examiners one or more of the queues of data in order to filter, review, and/or respond if necessary. In other embodiments, the data in one or more queues is filtered by the processing device of the enterprise system running the CRM application 610.

The next step, as represented by block 516, is to determine whether the data is an engagement opportunity. If the data is an engagement opportunity, and if necessary, a case is created, as represented by block 520. In some embodiments, if a new case is created and the data is associated with the new case, the case/data is re-routed to another queue for further review. For example, in one embodiment, a new case is created when the enterprise system determines the data is ripe for engagement, whereas no case had been created previously by the system or manually. In such a situation, the case/data may be forwarded or re-routed based on re-routing workflow rules to the appropriate queue for evaluation by an appropriate associate of the enterprise or for automatic review by the enterprise system or some other system in order to determine the appropriate response, if any. If the data is determined not to be an engagement opportunity, then the data is ignored and/or labeled as having been reviewed and retained in case there is a future need for further review of the data, as represented by block 518.

In some embodiments, for example, one or more messages were authored by a user making clearly inflammatory statements regarding the enterprise without specific focus regarding any particular, cognizable problem. In some such cases, the enterprise may predetermine engagement rules for filtering such inflammatory messages from those data/messages being considered for engagement. In other embodiments, the engagement rules flag one or more messages for purging and an associate of the enterprise manually confirms the purging of the messages before they are removed from the system.

Once the case/data has been re-routed if necessary, the next step, as represented by decision block 522, is to determine whether there is an API associated with the social media system integrated with the CRM system. If there is an appropriate API integrated with the CRM system (enterprise system running a CRM application), then the system posts one or more messages using the integrated API, as represented by block 526. In some embodiments, the system automatically posts or creates one or more messages, and in other embodiments, the system provides a user interface for receiving input regarding the one or more messages from an enterprise associate. Next, as represented by block 528, the enterprise system transmits one or more messages to the external site, such as a social media system, via the social media system's integrated API. In various embodiments, different publishing methods are used. For example, in one embodiment, Twitter® is being used for publication and the General Tweet, @Reply, DDM and/or similar functions are used for publication as necessary. As another example, in another embodiment, Facebook® is being used for publication and the Wall Post, Comment, Notification/Email and/or similar functions are used for publication as necessary. As another example, in one embodiment, YouTube® is being used for publication and the Comment or other similar functions are used for publication as necessary.

In some embodiments, as represented by block 530, the enterprise system records one or more messages, such as in a datastore. Such data can be retrieved subsequently for analysis and/or to fulfill documenting requirements in particular industries, such as, for example, the banking industry.

If there is not an appropriate API integrated with the CRM system, then the system posts one or more messages through the external site, as represented by block 524. In many social media configurations or other media systems, such as those configured for providing blogs and/or forums, no APIs exist, or it would be cost-ineffective for an enterprise to integrate the API because of the low volume of outgoing messages to that specific media system. In one application, for example, the enterprise system accesses the specific social media system, such as a blog or forum, in a frame of the user interface and receives input regarding one or more messages to post to the social media site. The enterprise system, in this example, in some embodiments, authenticates an associate of the enterprise automatically such that the associate can post one or more messages more efficiently, such as in response to data having been reviewed and determined an appropriate engagement opportunity. In various embodiments, different publication methods are used. For example, in one embodiment, a forum is being used for publication and New Thread, Reply, Personal Message (PM) and/or similar functions are used for publication. In another embodiment, for example, a blog is being used for publication and a Blog Post, Comment, PM and/or similar functions are used for publication.

Next, as represented by block 532, the enterprise system running the social media integration application, in some embodiments, records and/or monitors keystrokes and/or other message information and also records the one or more messages in the CRM system as represented by block 530, such as in a datastore.

In some embodiments, a Twitter® API is integrated with the social media integration application 609 (FIG. 6) such that messages, follower requests, follower profiles and/or stats, and the like can be used by the enterprise system. In some embodiments, a Facebook® API is integrated with the social media integration application such that notifications, wall posts, comments, friend profiles and/or stats, and the like can be used by the enterprise system. In some embodiments, the YouTube® API is integrated with the social media integration application such that comments, subscriptions and the like can be used by the enterprise system.

Referring now to FIG. 6, a block diagram of a social media engagement environment 600 in which the various methods described herein are performed is shown according to embodiments of the present invention. An enterprise system 601 is a computer system, server, multiple computer systems and/or servers or the like. The enterprise system 601, in the embodiments shown has a communication device 612 communicably coupled with a processing device 614, which is also communicably coupled with a memory device 616. The processing device is configured to control the communication device 612 such that the enterprise system 601 communicates across the network 602 with one or more other systems. The processing device is also configured to access the memory device 616 in order to read the computer readable instructions 618, which in some embodiments include a social media integration application 609 and a CRM, workflow and/or case management system/platform application 610 or “CRM application”. The memory device 616 also has a datastore 619 or database for storing pieces of data for access by the processing device 614. The enterprise system 601 is maintained and/or owned by a financial institution such as a bank in some embodiments. Similarly, in various embodiments one or more of the other systems discussed herein are maintained and/or owned by a financial institution, such as a bank.

The social media integration application 609 is configured for instructing the processing device 614 to perform various steps of the methods discussed herein, such as, but not limited to, steps 506, 508, 522, 524, 526, 528, 530, 532, and/or other steps and/or similar steps. The CRM application 610 is configured for instructing the processing device 614 to perform various steps of the methods discussed herein, such as, but not limited to steps 510, 512, 514, 516, 518, 520, and/or other steps and/or similar steps. In various other embodiments, various CRM platforms and/or combination of CRM platforms are used to perform some of the steps discussed herein with reference to the CRM application 610. As used herein, the term “CRM system” refers to a system having the CRM application 610 stored in a memory device and accessed by a processing device, such as the enterprise system 601.

In various embodiments, the social media integration application 609 is included in the computer readable instructions stored in a memory device of one or more systems other than the enterprise system 601. For example, in some embodiments, one or both the social media integration application 609 and the CRM application 610 are stored and configured for being accessed by a processing device of a third party system 608.

A user system 604 is configured for use by a user 606 such as a customer and/or client of the enterprise. The user system 604 is a computer system, server, multiple computer system, multiple servers, a mobile device or some other computing device configured for use by a user. The user system 604 has a communication device 622 communicatively coupled with a processing device 624, which is also communicatively coupled with a memory device 626. The processing device 624 is configured to control the communication device 622 such that the user system 604 communicates across the network 602 with one or more other systems. The processing device 624 is also configured to access the memory device 626 in order to read the computer readable instructions 628, which in some embodiments include a web browser application 620 and a social media engagement application 611. The memory device 626 also has a datastore 629 or database for storing pieces of data for access by the processing device 624. The web browser application 620 is configured to provide the user 606 a user interface for navigating the Internet, and the social media engagement application 611 is configured to provide the user an interface for accessing the CRM system. For example, in one embodiment, the user is an enterprise associate and is accessing the CRM system in order to review one or more queues and prepare and communicate appropriate responses. In such an embodiment, the social media engagement application 611 is configured to communicate and work in conjunction with the CRM system such that the enterprise associate has access to necessary system functionality. In various other embodiments, the social media engagement application 611 is configured to communicate and cooperate with one or more other systems such that the user, such as an enterprise associate, has access to appropriate functionality for the user's purposes. In another embodiment, for example, the user is a customer who authors one or more messages regarding the enterprise, and the social media engagement application 611 is or includes a web browser application configured to access and interact with one or more social media systems 603.

The media system 603, which is represented in FIG. 5 as one of the cloud of social media systems 502, is configured for providing a social media service to people. For example, one or more media systems 603 are configured for pushing social media content onto the Internet and receiving input from millions of users in a wide variety of formats. In some embodiments, the media system 603 includes a communication device 642 communicatively coupled with a processing device 644, which is also communicatively coupled with a memory device 646. The processing device 644 is configured to control the communication device 642 such that the media system 603 communicates across the network 602 with one or more other systems. The processing device 644 is also configured to access the memory device 646 in order to read the computer readable instructions 648, which in some embodiments include a social media application 640 for instructing the processing device 644 for providing the social media service to the various users. The memory device 646 also has a datastore 649 or database for storing pieces of data for access by the processing device 644, such as, for example, data regarding the users having profiles within the social media service.

The third party system 608 is configured for providing one or more of the systems and/or applications for use with the social media engagement system, including, for example, a CRM system. For example, in various embodiments, one or more third party systems 608 store and provide access to one or more of the social media integration application 609, the CRM application 610, the social media engagement application 611, the social media application 640, the social media data aggregation application 630, some other application used in the environment 600, or some other application used with regard to one or more of the methods discussed herein. In some embodiments, the third party system 608 includes a communication device 632 communicatively coupled with a processing device 634, which is also communicatively coupled with a memory device 636. The processing device 634 is configured to control the communication device 632 such that the third party system 608 communicates across the network 602 with one or more other systems. The processing device 634 is also configured to access the memory device 636 in order to read the computer readable instructions 638, which in some embodiments include one or more of the social media integration application 609, the CRM application 610, the social media engagement application 611, the social media data aggregation application 630, the social media application 640, some other application used in the environment 600, or some other application used with regard to one or more of the methods discussed herein. In the specific embodiment shown in FIG. 6, the social media data aggregation application 630 configured for instructing the processing device 634 for performing one or more of the method steps discussed herein, such as, but not limited to, step 504. The memory device 646 also has a datastore 649 or database for storing pieces of data for access by the processing device 644.

In various embodiments, one of the systems discussed above, such as the enterprise system 601, is more than one system and the various components of the system are not collocated, and in various embodiments, there are multiple components performing the functions indicated herein as a single device. For example, in one embodiment, multiple processing devices perform the functions of the processing device 614 of the enterprise system 601 described herein.

Referring now to FIGS. 7A-7C, screenshots of a social media engagement platform according to embodiments of the present invention are illustrated. FIG. 7A illustrates a screenshot of a social media engagement system console 700A configured for providing an enterprise associate to manage social media data. The screen layout of the console 700A provides quick access to pertinent information and functions need to manage incoming data. Window 710 illustrates a list of pieces of data, such as messages. In the example shown, the data is a list of tweets, or messages on the social media platform Twitter®. This list of messages is a list generated from aggregated search results and routed to an enterprise-specific account or queue specified for receiving a specific set of messages. A link 712 to open a particular case associated with the message to the right of the link is provided. The console provides the associate the ability to perform various functions as shown, including the ability to send a Twitter® message, via button 714, to the customer originating a message and/or associated with a contact record and/or case. Window 716 illustrates a collection of information associated with the customer or user such as identification information, username, location and information regarding followers of the user and the status of the user. The information regarding followers may provide useful data for the enterprise for tracking influence of particular responses as well as influence of specific messages authored by users/customers.

Referring now to FIG. 7B, a screenshot of the social media engagement system console 700B showing the cases tab is shown. Some of the information included in the case detail is the case owner 718, the status of the case 720, an identification number 722, such as the corresponding commit/tracker ID. Window 724 includes the history of the messages sent back and forth between the customer and the enterprise. Window 726 includes a section for enterprise associates to add comments and/or notes to the case. Window 728 includes a searchable knowledge repository for enterprise associates to use when reviewing and preparing responses to customer messages.

In various embodiments, the social media engagement system is configured for initiating presentation of the social media engagement console to a user, the social media console providing immediate access from the console into at least two of one or more queues, one or more case details, one or more contact details, and one or more case messages. In other words, the console provides the user with vision into multiple pieces of the social media engagement system simultaneously and immediately. For example, in one embodiment, the console includes a plurality of preview panes displayed for the user's consideration. In some embodiments, for example, the preview panes include information related to some or all of the queues into which the messages have been routed, one or more case details associated with the particular case currently being reviewed by the user, one or more contact details, such as information related to the creator of the original social media messages under consideration by the user, and/or one or more case messages. In some instances, for example, some of the messages associated with the case can be removed for easier viewing of more important messages all on one console screen. Hence, the console provides an opportunity to view numerous pieces of data and messages, thereby providing a user ease in reviewing information related to a case and preparing appropriate responses related to the case.

Referring now to FIG. 7C, a screenshot of the social media engagement system console 700C showing the dashboard tab is shown. Various graphical tools are provided for the use of the enterprise associate. For example, the tweet volume trend, that is, volume by day is illustrated in chart 730. Tweets by category are illustrated in chart 732. The tweet volume by type is illustrated in chart 734, and the top customer tweeters are illustrated in chart 736. The open cases by line of business (LOB) is shown in graph 738, and the open cases by representative or enterprise associate is shown in graph 740. The average resolution time by LOB is illustrated in graph 742. The cumulative number of customers serviced is shown in graph 744, and the number of people exposed to positive tweets is illustrated in graph 746. This information, as discussed above, can be helpful in analysis of the positive and/or negative impact the various social media data has on the enterprise. Finally, the customer feedback trending, which indicates the percentage of service interactions ending in positive versus negative feedback is shown in illustration 748.

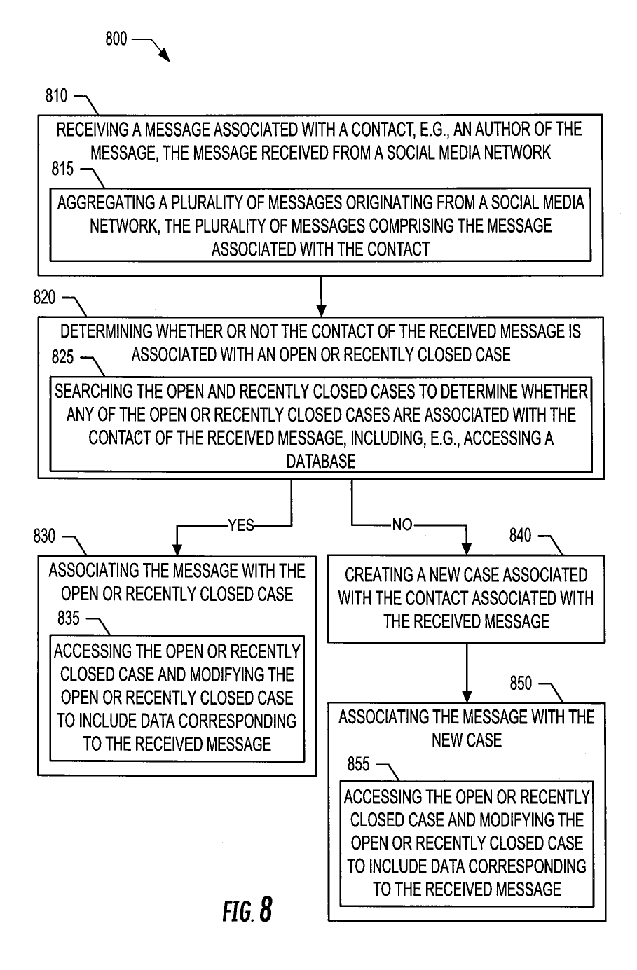

Referring now to FIG. 8, a flowchart illustrates a method 800 for message case association according to embodiments of the invention. The first step, as represented by block 810, is receiving a message from a social media network. The message is typically associated with a contact. For example, in some embodiments, a contact is an author of the message. Sub-step 815 is aggregating a plurality of messages originating from the social media network. In some embodiments, the plurality of messages includes the message associated with the contact. The next step, as represented by block 820, is determining whether or not the contact of the received message is associated with an open or recently closed case. Sub-step 825 is searching the open and recently closed cases to determine whether any of the open or recently closed cases are associated with the contact of the received message, including, for example, accessing a database containing the open or recently closed cases. If so, the next step, represented by block 830, is associating the message with the open or recently closed case. Sub-step 835 is accessing the open or recently closed case and modifying the open or recently closed case to include data corresponding to the received message. If not, the next step, represented by block 840 is creating a new case associated with the contact associated with the received message. Finally, the next step, as represented by block 850, is associating the message with the new case. Sub-step 855 is accessing the open or recently closed case and modifying the open or recently closed case to include data corresponding to the received message.

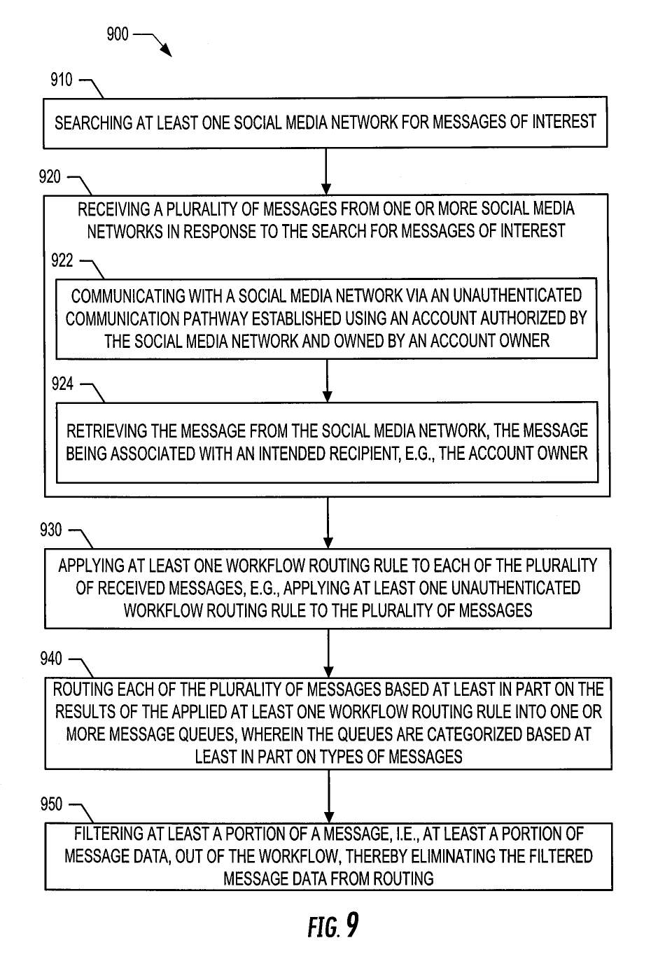

Referring now to FIG. 9, a flowchart illustrates a method 900 for message routing according to embodiments of the invention. The first step, as represented by block 910, is searching at least one social media network for messages of interest. The next step, as represented by block 920, is receiving a plurality of messages from one or more social media networks in response to the search for messages of interest. Included in some embodiments of step 920 are sub-steps 922 and 924. Sub-step 922 is communicating with a social media network via an unauthenticated communication pathway established using an account authorized by the social media network and owned by an account owner. Sub-step 924 is retrieving the message from the social media network. In some embodiments, the message is associated with an intended recipient, for example, the account owner in some embodiments. The next step, as represented by block 930, is applying at least one workflow routing rule to each of the plurality of received messages. For example, in some embodiments, this includes applying at least one unauthenticated workflow routing rule to the plurality of messages. The next step, as represented by block 940, is routing each of the plurality of messages based at least in part on the results of the applied at least one workflow routing rule into one or more message queues, wherein the queues are categorized based at least in part on types of messages. The last step, as represented by block 950, is filtering at least a portion of a message, such as at least a portion of message data, thereby eliminating the filtered message data from routing.

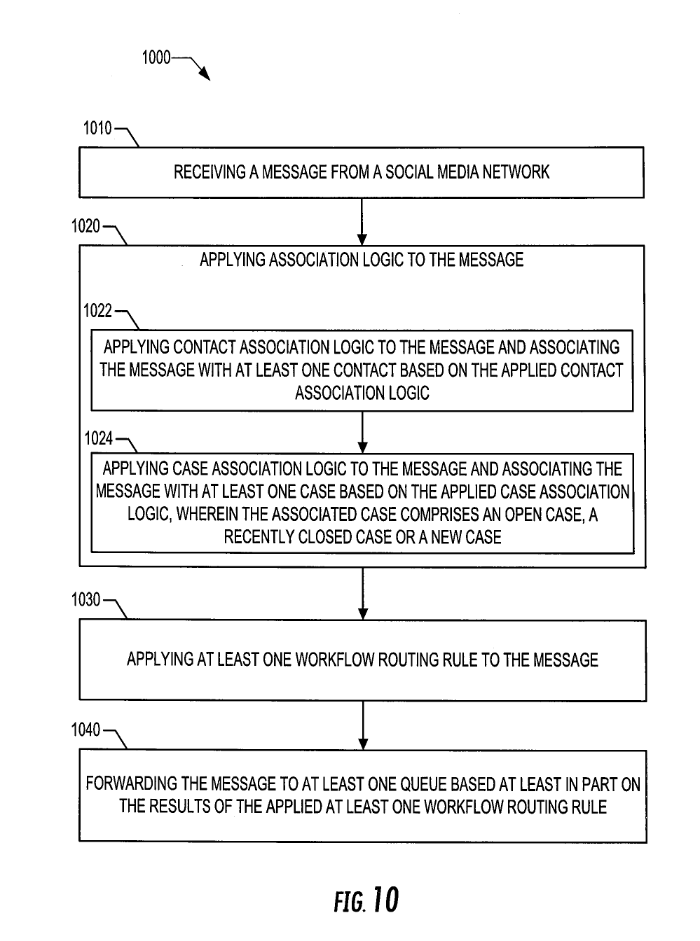

Referring now to FIG. 10, a flowchart illustrates a method 1000 for processing a message according to embodiments of the invention. The first step, as represented by block 1010, is receiving a message from a social media network. The message, in various embodiments, may be received as a result of a search or may be received as a result of an affirmative transmittal from an outside source. The next step, as represented by block 1020, is applying association logic to the message. In some embodiments, step 1020 includes sub-step 1022, which includes applying contact association logic to the message and associating the message with at least one contact based on the applied contact association logic. In some embodiments, step 1020 includes sub-step 1024, which includes applying case association logic to the message and associating the message with at least one case based on the applied case association logic. In some embodiments, the associated case includes an open case or a recently closed case, and in other embodiments, the associated case includes a new case. The case association logic, as discussed above, may include, in various embodiments, a determination of the source of the message. The logic may also include rules dictating the message be associated with a particular case based on the subject of the message or the inclusion of keywords within the message. In yet other rules for associating the message with the case, in various embodiments, the message is associated with a case based on metadata associated with the message, such as data indicating the message is related to other messages already associated with a particular case. The next step, as represented by block 1030, is applying at least one workflow routing rule to the message. The final step, as represented by block 1040, is forwarding the message to at least one queue based at least in part on the results of the applied at least one workflow routing rule.

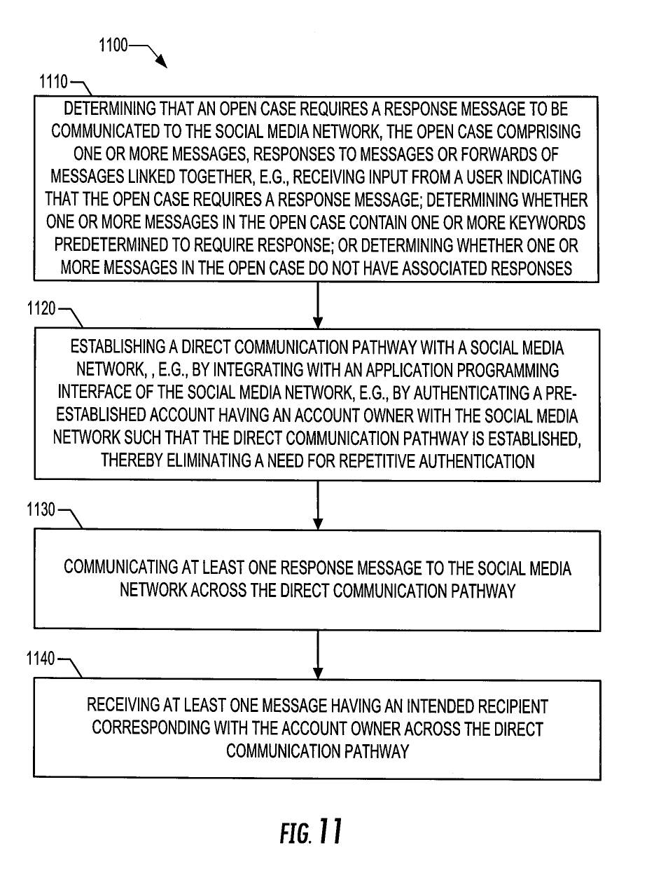

Referring now to FIG. 11, a flowchart illustrates a method 1100 for interacting with a social media network, for example, by a social media engagement system, according to embodiments of the invention. The first step, as represented by block 1110, is determining that an open case requires a response message to be communicated to the social media network. In various embodiments, the open case includes one or more messages, responses to messages, and/or forwards of messages linked together. For example, in one embodiment, step 1110 includes receiving input from a user indicating that the open case requires a response message. In another example embodiment, step 1110 includes determining whether one or more messages in the open case contain one or more keywords predetermined to require response. In yet another example embodiment, step 1110 includes determining whether one or more messages in the open case do not have associated responses. The next step, as represented by block 1120, is establishing a direct communication pathway with a social media network. For example, in one embodiment, step 1120 includes integrating with an application programming interface of the social media network. In some embodiments, step 1120 includes authenticating a pre-established account having an account owner with the social media network such that the direct communication pathway is established, thereby eliminating a need for repetitive authentication. Next, as represented by block 1130, at least one response is communicated to the social media network across the direct communication pathway. In some embodiments, the response is drafted manually, that is, by a user; however, in some embodiments, the response is initially drafted by an automated system. For example, with regard to frequently asked questions, a couched response is stored and provided as the response. One example, is a message requesting the hours of a branch location, which can be easily transmitted as a response to the requester. Furthermore, in some such embodiments, such automated responses can be reviewed by a user before being published and/or privately sent as a response to the original message. As represented by block 1140, at least one message having an intended recipient corresponding with the account owner is received across the direct communication pathway. In some embodiments, the at least one message is received and one or more responses are generated based on the received message and then communicated. In some embodiments, the message having an intended recipient is received after at least one response is communicated to the social media network or both.

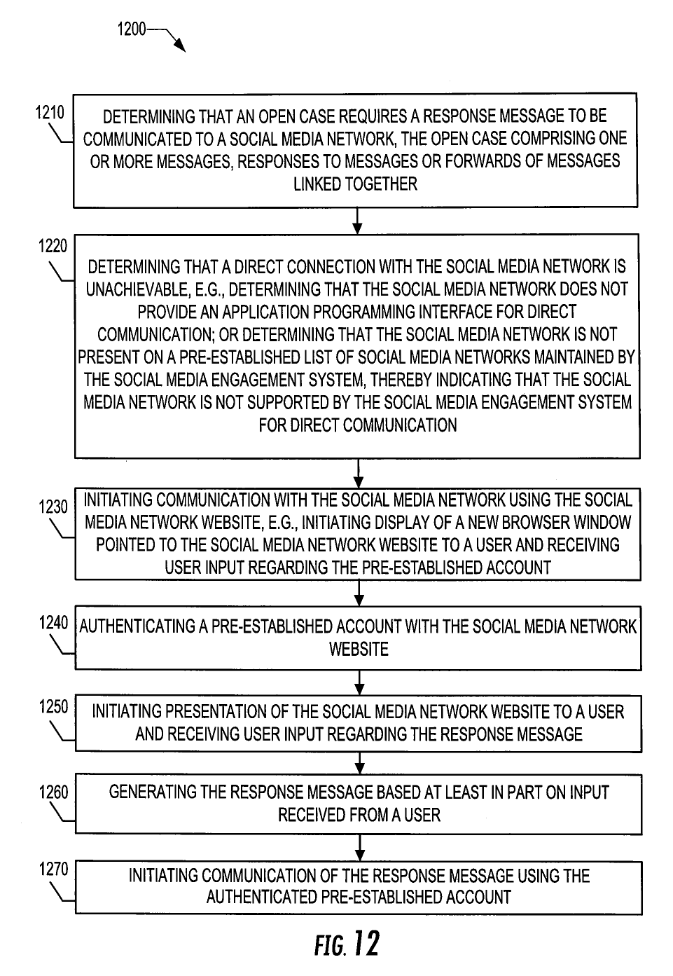

Referring now to FIG. 12, a method 1200 for communicating with a social media network using a social media engagement system is illustrated according to embodiments of the invention. The first step, as represented by block 1210, is determining that an open case requires a response message to be communicated to a social media network. The open case, in some embodiments, includes one or more messages, responses, responses to messages and/or forwards of messages linked together. The next step, as represented by block 1220, is determining that a direct connection with the social media network is unachievable. For example, in some embodiments, step 1220 includes determining that the social media network does not provide an application programming interface for direct communication. In other example embodiments, step 1220 includes determining that the social media network is not present on a pre-established list of social media networks maintained by the social media engagement system, such as on a database, thereby indicating that the social media network is not supported by the social media engagement system for direct communication. The next step, as represented by block 1230, is initiating communication with the social media network using the social media network website. For example, in some embodiments, step 1230 includes initiating display of a new browser window pointed to the social media network website to a user and receiving user input regarding the pre-established account. The next step, as represented by block 1240, is authenticating a pre-established account with the social media network website. The next step, as represented by block 1250, is initiating presentation of the social media network website to a user and receiving user input regarding the response message. The next step, in some embodiments, as represented by block 1260, is generating the response message based at least in part on input received from the user. As discussed above, in some embodiments, the response message is drafted automatically and/or drafted automatically and forwarded to a user for review being published. The next step, as represented by block 1270, is initiating communicating of the response message using the authenticated pre-established account.

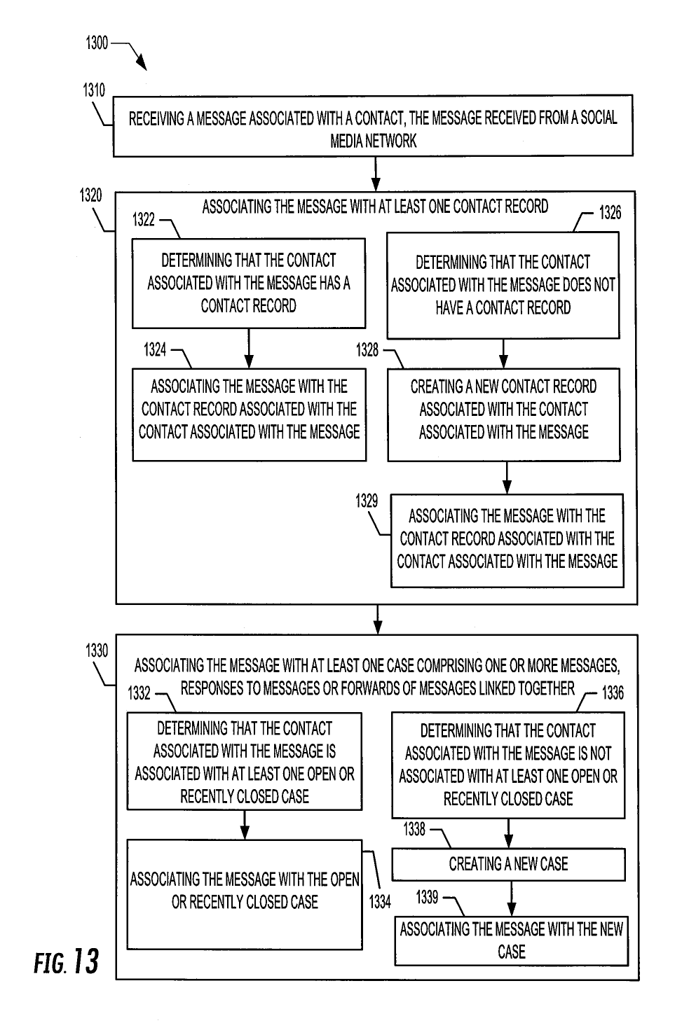

Referring now to FIG. 13, a method 1300 for message association is illustrated according to embodiments of the invention. The first step, as represented by block 1310, is receiving a message received from a social media network and associated with a contact. The next step, as represented by block 1320, is associating the message with at least one contact record. If the contact associated with the message has a contact record, as represented by block 1322, then the message is associated with the contact record associated with the contact associated with the message, as represented by block 1324. If the contact associated with the message does not have a contact record, as represented by block 1326, then a new contact record associated with the contact is created. Then, as represented by block 1329, the message is associated with the contact record associated with the contact associated with the message. The next step, as represented by block 1330, is associating the message with at least one case including one or more messages, responses to messages, and/or forwards of messages linked together. If the contact associated with the message is associated with at least one open or recently closed case, as represented by block 1332, then the message is associated with the open or recently closed case, as represented by block 1334. In some instances, the contact record associated with the message is associated with more than one case. In some such instances, various rules may be implemented to determine which open and/or recently closed case with which the message should be associated. For example, in one embodiment, a keyword comparison of the words within the message and the words within the messages associated with the various open and/or recently closed cases can be made with the closes keyword association, thereby indicating that the message should be associated with that case. If the contact associated with the message is not associated with at least one open or recently closed case, as represented by block 1336, then a new case is created and the message is associated with the new case, as represented by blocks 1338 and 1339, respectively.

In various embodiments of the invention, the social media engagement system, such as, for example, the enterprise system discussed above, is configured for retrieving one or more social media profiles from the one or more social media networks. The one or more social media profiles correspond with one or more of the plurality of messages, that is, the messages are associated with one or more social media profiles. For example, in one embodiment, a user of the social media network having an account associated with a social media profile composes and publishes a message. In this example, the published message is associated with the social media profile of the creator of the message. Some social media networks provide influence, such as the number of followers of a particular user. Thus, a message published by the user is consider to have influenced all of those other users who follow the creator of the message. The social media engagement system, by downloading the social media profiles, which include information related to the influence of messages associated with those social media profiles, then analyzes the one or more social media profiles to distill influence information indicating an influence of one or more of the plurality of messages. In some embodiments, contacts and/or cases and/or creator or users having a certain determined and/or predicted influence are scheduled for remediation, such as preparing a response message, based at least in part on the determined and/or predicted influence. In some embodiments, for example, the determined influences of the messages and/or cases being considered within a particular queue are used to prioritize review of the messages and/or cases within the queue. For example, a message with a very high influence, or a message originating from an account of a user with a very high influence may be forwarded to the front of the queue over a message with a very low influence or originating from a user with a very low influence. In other embodiments, for example, the influence of the enterprise messages is tracked in order to determine number of requests serviced.

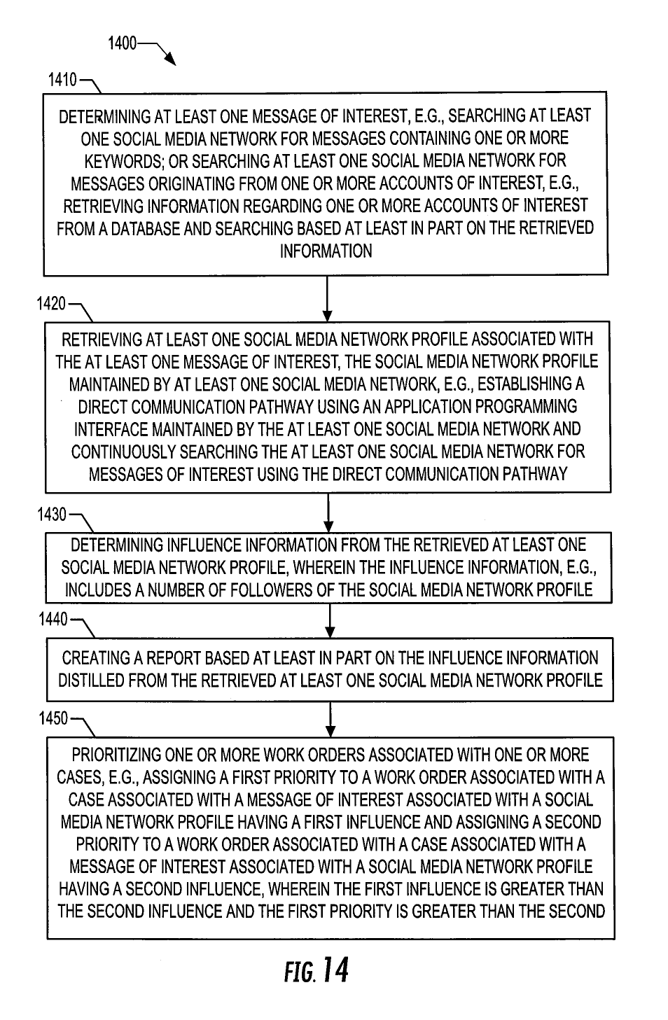

Referring now to FIG. 14, a method 1400 for tracking influence over at least one social media network is illustrated according to embodiments of the invention. The first step, as represented by block 1410, is determining at least one message of interest. For example, in one embodiment, step 1410 includes searching at least one social media network for messages containing one or more keywords. In another embodiment, for example, step 1410 includes searching at least one social media network for messages originating from one or more accounts of interest, such as, for example, by retrieving information regarding the one or more accounts of interest from a database and searching based at least in part on the retrieved information. The next step, as represented by block 1420, is retrieving at least one social media network profile associated with the at least one message of interest. The social media network profile is, in some instances, maintained by at least one social media network. For example, in one embodiment, step 1420 includes establishing a direct communication pathway using an application programming interface as discussed above. Then, in some such embodiments, step 1420 includes continuously searching the at least one social media network for messages of interest using the direct communication pathway. The next step, as represented by block 1430, is determining influence information from the retrieved at least one social media network profile, wherein the influence information includes, for example, a number of followers of the social media network profile. The next step, as represented by block 1440, is creating a report based at least in part on the influence information distilled from the retrieved at least one social media network profile. The final step, in some embodiments, as represented by block 1450, is prioritizing one or more work orders associated with one or more cases. For example, in some embodiments, step 1450 includes assigning a first priority to a work order associated with a case associated with a message of interest associated with a social media network profile having a first influence. In such embodiment, step 1450 also includes assigning a second priority to a work order associated with a case associated with a message of interest associated with a social media network profile having a second influence. In these embodiments, the first influence is greater than the second influence and the first priority is greater than the second priority. Accordingly, a relatively higher priority is assigned to work orders involving matters of higher influence.

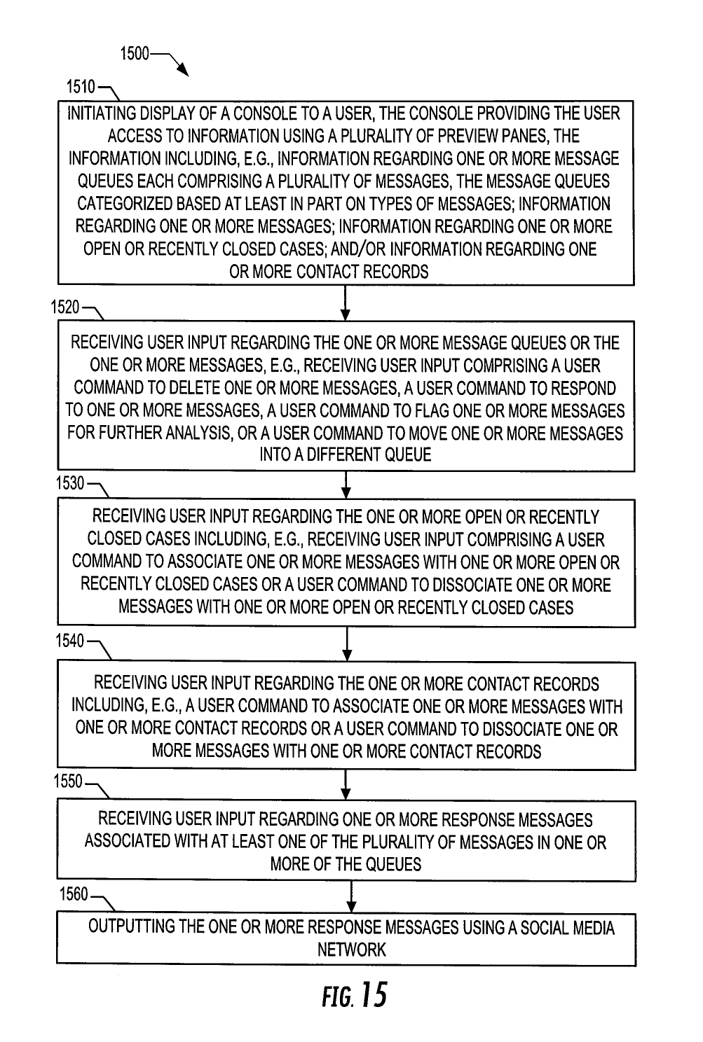

Referring now to FIG. 15, a method 1500 for providing a console to a user of a social media engagement system according to embodiments of the invention. In various embodiments, the terms “dashboard” and “console” are used interchangeably. That is, in some embodiments, the system provides both a dashboard and a console having separate and distinct functionality as shown in FIG. 7; however, as used herein, both a dashboard and a console can have similar or identical functionality. Either or both can display information and/or receive input from a user, among other functions. Referring back to FIG. 15, the first step, as represented by block 1510, is initiating display of a console to a user. The console, in some embodiments, provides a user access to information using a plurality of preview panes. The information, in various embodiments, includes information regarding one or more message queues each including a plurality of messages. In some embodiments, the message queues are categorized based at least in part on types of messages. In other embodiments, the information includes information regarding one or more messages, information regarding one or more open or recently closed cases, and/or information regarding one or more contact records. The next step, as represented by block 1520, is receiving user input regarding the one or more message queues or the one or more messages. For example, in one embodiment, step 1520 includes receiving user input including a user command to delete one or more messages, a user command to respond to one or more messages, a user command to flag one or more messages for further analysis, and/or a user command to move one or more messages into a different queue. The next step, as represented by block 1530, is receiving user input regarding the one or more open or recently closed cases including, for example, receiving user input comprising a user command to associate one or more messages with one or more open or recently closed cases or a user command to dissociate one or more messages with one or more open or recently closed cases. The next step, as represented by block 1540, is receiving user input regarding the one or more contact records including, for example, a user command to associate one or more messages with one or more contact records or a user command to dissociate one or more messages with one or more contact records. The next step, as represented by block 1550, is receiving user input regarding one or more response messages associated with at least one of the plurality of messages in one or more of the queues. Finally, as represented by block 1560, the last step is outputting the one or more response messages using a social media network.

Embodiments of the invention provide for systems for social media engagement. The system, in various embodiments, has a processing device configured for aggregating a plurality of messages originating from a plurality of social media networks, routing each of the plurality of messages based on predetermined workflow rules into a plurality of queues wherein the queues are categorized based at least in part on types of messages, providing the queues for further processing, thereby resulting in one or more responses, and outputting the one or more responses to one or more of the plurality of social media networks. In some embodiments, the system is further configured for reviewing the data to determine whether any of the data indicates an engagement opportunity and associating some or all the data with a contact record and/or an existing case and/or a new case. In some embodiments, the system tracks influence, and in some embodiments, a console provides vision into various information provided by the system.

Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As used herein, a “bank card” refers to a credit card, debit card, ATM card, check card, or the like, or other payment device such as, but not limited to, those discussed above that are not cards. An “account” or “bank account” refers to a credit account, debit account, deposit account, demand deposit account (DDA), checking account, budgeting account or the like. Although the phrases “bank card” and “bank account” include the term “bank,” the card or payment device need not be issued by a bank, and the account need not be maintained by a bank and may instead be issued by and/or maintained by other financial institutions.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for processing a message, the method comprising:
receiving a message from a social media network;
applying, using a processing device, association logic to the message;
associating the message with at least one of a contact or a case based at least in part on the results of the applied association logic;
applying at least one workflow routing rule to the message; and
forwarding the message to at least one queue based at least in part on the results of the applied at least one workflow routing rule.

2. The method of claim 1, wherein applying association logic to the message comprises applying contact association logic to the message and associating the message with at least one contact based on the applied contact association logic.

3. The method of claim 1, wherein applying association logic to the message comprises applying case association logic to the message and associating the message with at least one case based on the applied case association logic.

4. The method of claim 3, wherein the associated case comprises an open case or a recently closed case.

5. The method of claim 3, further comprising creating a new case and associating the message with the new case.

6. The method of claim 1, wherein the message is associated with a contact and wherein associating the message with at least a contact or a case comprises associating the message with a contact record based at least in part on the contact associated with the message.

7. The method of claim 3, wherein the message is associated with a contact and wherein associating the message with at least a contact or a case comprises associating the message with a contact record based at least in part on the contact associated with the message.

8. A system for processing a message, the system comprising a processing device configured for:
receiving a message from a social media network;
applying association logic to the message;
associating the message with at least one of a contact or a case based at least in part on the results of the applied association logic;
applying at least one workflow routing rule to the message; and
forwarding the message to at least one queue based at least in part on the results of the applied at least one workflow routing rule.

9. The system of claim 8, wherein applying association logic to the message comprises applying contact association logic to the message and associating the message with at least one contact based on the results of the applied contact association logic.

10. The system of claim 8, wherein applying association logic to the message comprises applying case association logic to the message and associating the message with at least one case based on the results of the applied case association logic.

11. The system of claim 10, wherein the associated case comprises an open case or a recently closed case.

12. The system of claim 10, wherein the processing device is further configured for creating a new case and associating the message with the new case.

13. The system of claim 8, wherein the message is associated with a contact and wherein associating the message with at least a contact or a case comprises associating the message with a contact record based at least in part on the contact associated with the message.

14. The system of claim 10, wherein the message is associated with a contact and wherein associating the message with at least a contact or a case comprises associating the message with a contact record based at least in part on the contact associated with the message.

15. A computer program product for processing a message, the computer program product comprising a non-transient computer-readable memory comprising computer-readable instructions, the instructions comprising:
instructions for receiving a message from a social media network;
instructions for applying association logic to the message;
instructions for associating the message with at least one of a contact or a case based at least in part on the results of the applied association logic;
instructions for applying at least one workflow routing rule to the message; and
instructions for forwarding the message to at least one queue based at least in part on the results of the applied at least one workflow routing rule.

16. The computer program product of claim 15, wherein the instructions for applying association logic to the message comprise instructions for applying contact association logic to the message and instructions for associating the message with at least one contact based on the applied contact association logic.

17. The computer program product of claim 15, wherein the instructions for applying association logic to the message comprise instructions for applying case association logic to the message and instructions for associating the message with at least one case based on the applied case association logic.

18. The computer program product of claim 17, wherein the associated case comprises an open case or a recently closed case.

19. The computer program product of claim 17, wherein the instructions further comprise creating a new case and associating the message with the new case.

20. The computer program product of claim 15, wherein the message is associated with a contact and wherein the instructions for associating the message with at least a contact or a case comprise instructions for associating the message with a contact record based at least in part on the contact associated with the message.

21. The computer program product of claim 17, wherein the message is associated with a contact and wherein the instructions for associating the message with at least a contact or a case comprise instructions for associating the message with a contact record based at least in part on the contact associated with the message.

22. A method for processing a message, the method comprising:
receiving a message from a social media network;
applying, using a processing device, association logic to the message comprising:
applying contact association logic to the message,
associating the message with at least one contact based on the applied contact association logic,
applying case association logic to the message, and
associating the message with at least one case based on the applied case association logic;
associating the message with at least one of a contact or a case based at least in part on the results of the applied association logic;
applying at least one workflow routing rule to the message; and
forwarding the message to at least one queue based at least in part on the results of the applied at least one workflow routing rule.

23. The method of claim 22, wherein the associated case comprises an open case or a recently closed case.

24. The method of claim 22, further comprising creating a new case and associating the message with the new case.

25. A system for processing a message, the system comprising a processing device configured for:
receiving a message from a social media network;
applying association logic to the message comprising:
applying contact association logic to the message,
associating the message with at least one contact based on the applied contact association logic,
applying case association logic to the message, and
associating the message with at least one case based on the applied case association logic;
associating the message with at least one of a contact or a case based at least in part on the results of the applied association logic;
applying at least one workflow routing rule to the message; and
forwarding the message to at least one queue based at least in part on the results of the applied at least one workflow routing rule.

26. The system of claim 25, wherein the associated case comprises an open case or a recently closed case.

27. The system of claim 25, wherein the processing device is further configured for creating a new case and associating the message with the new case.
